(19) United States
(12) Patent Application Publication
(10) Pub. No.: US 2006/0059320 A1
(43) Pub. Date: Mar. 16, 2006

(54) Memory control device

(76) Inventor: Mamiko Akizuki, Ehime (JP)

Correspondence Address: STEPTOE & JOHNSON LLP, 1330 CONNECTICUT AVENUE, N.W., WASHINGTON, DC, 20036, US

(21) Appl. No.: 10/541,024

(22) PCT Filed: Jan. 26, 2004
(86) PCT No.: PCT/JP04/00671

§ 371 Date: Jun. 28, 2005

(30) Foreign Application Priority Data
Jan. 27, 2003 (JP) 2003-017372

(51) Int. Cl. G06F 12/00

(52) U.S. Cl. 711/158; 711/5

(57) ABSTRACT

It is an object of the present invention to provide a memory controller which prevents successive access to the same bank of SDRAM and improves processing time. A memory controller (105) of the present invention is a memory controller for controlling memory which has a plurality of banks and can make successive access in bank split mode. The memory controller (105) controls the priority of a plurality of blocks in such a way that memory access requests from blocks (804, 805, and 806), which make access to SDRAM (808) via the memory controller (105), are caused to access the different banks of the SDRAM (808).

### TECHNICAL FIELD

The present invention relates to a memory controller for controlling memory constituted of a plurality of banks in electronic equipment.

### BACKGROUND ART

In recent years, synchronous dynamic random access memory (hereinafter, abbreviated as SDRAM) has become available which can perform high-speed burst transfer of cache memory, which is frequently used in personal computers, in synchronization with a clock. The SDRAM can switch between a continuous access mode and a random access mode by means of a bank split mode. The bank split mode has, as four memory areas, a bank 0 where a two-bit bank signal is “00”, a bank 1 where the bank signal is “01”, a bank 2 where the bank signal is “10”, and a bank 3 where the bank signal is “11.” Access is performed while switching among the bank 0, the bank 1, the bank 2, and the bank 3 by means of clock control. The address of a subsequent bank can be captured while data is read from the initially accessed bank.

As shown in FIG. 18, a memory controller 801 for controlling the SDRAM is constituted of a memory control unit 802 and an arbitration/Wait signal generating section 803. Access from a plurality of blocks 804, 805, 806, and 807 to the SDRAM 808 is controlled (e.g., see JP8-212170A).

A memory address signal (MADR), a data signal (DATA), and a reading/writing control signal (RD/WR) are inputted from the plurality of blocks 804, 805, 806, and 807 to memory control sections 809, 810, 811, and 812 which correspond to the blocks, respectively. Memory access request signals (CS) from the plurality of blocks 804, 805, 806, and 807 are inputted to an arbitration/Wait signal generating section 803, and a wait signal (Wait) is returned from the arbitration/Wait signal generating section 803 to the plurality of blocks 804, 805, 806, and 807. Access from a permitted block to the SDRAM 808 is controlled by the memory control section corresponding to the block having received a memory access enabling signal (Enable) from the arbitration/Wait signal generating section 803. The following will describe an example of the read access timing of the SDRAM 808 by using the memory controller 801. In this case, the SDRAM 808 is operated in the bank split mode.

For example, the bit 10 and bit 3 of a memory address from the block are associated with the bank signal of the SDRAM. The bank 0 is selected for “00”, the bank 1 is selected for “01”, and the bank 2 is selected for “10”. As shown in FIG. 19, the memory command (FIG. 19(B)) and the memory address (FIG. 19(C)) are outputted to the SDRAM 808 while the row addresses (R0, R1, R2, and R3) and column addresses (C0, C1, C2, and C3) of the plurality of blocks are switched according to the clock (FIG. 19(A)). Data (FIG. 19(D)) D00 and D01 read from the bank 0 are outputted three clocks after a read command 901 for the bank 0 is inputted. D01 denotes data of an address following D00 and means that two-word data can be outputted by one address input. When only one-word data is necessary, D01 is unnecessary and is not transferred to the block where memory access has been performed. Until data is outputted, the number of clocks can be changed by mode setting which is called “CAS latency” and is provided in the SDRAM 808. Further, the number of data handled by one address input can be changed by mode setting called “burst length.” In this example, “CAS latency” is set at “3” and “burst length” is set at “2”.

In the case of final data, that is, two-word output, each bank is automatically precharged when the data D01 is outputted. Precharge is similarly performed on the bank 1, the bank 2, and the bank 3. Access to the bank 0, the bank 1, the bank 2, and the bank 3 is switched in this manner, so that access is continuously performed without intermission.

However, in the conventional memory controller, in the case where a single block accesses the SDRAM 808 in the bank split mode, when a memory address causing successive access to the same bank (e.g., the bank 1) is outputted, the bank 1 is accessed successively. In this case, any address cannot be outputted to the bank 1 until the completion of the precharge of the bank 1, resulting in a useless cycle disabling access to the SDRAM 808.

Thus, when a single block accesses the SDRAM 808, the above problem is considered to be solved by generating a memory address so as to prevent the single block from successively accessing the same bank. However, when a plurality of blocks access the SDRAM 808, it is extremely difficult to mutually control banks when the plurality of blocks perform memory access, so that the same bank may be accessed successively.

For example, when the block 805 accesses the bank 1 immediately after the block 804 accesses the bank 1, the same bank is accessed successively. In this case, any address cannot be outputted to the bank 1 until the precharge of the bank 1 is completed. That is, a useless cycle occurs which disables access to the SDRAM 808.

Further, in the conventional memory controller 801, when write access for writing data in the SDRAM 808 is performed after read access for reading data from the SDRAM 808, the specifications of the SDRAM 808 cause a useless cycle which disables access to the SDRAM 808. Hence, when read access requests from the plurality of blocks 804, 805, 806, and 807 are followed by write access requests, the number of cycles for accessing the SDRAM 808 is larger than the case where write access or read access is performed successively.

Moreover, the SDRAM 808 has to perform refresh every set period of time to store internal data and the refresh is performed during memory access from the plurality of blocks 804, 805, 806, and 807. When refresh is performed after write access requests from the plurality of blocks 804, 805, 806, and 807, a useless cycle occurs due to the specifications of the SDRAM 808.

An object of the present invention is to provide a memory controller by which processing time is improved by changing the priority of memory access so as to prevent successive access to the same bank of the SDRAM 808, the number of memory access cycles is reduced by changing the priority of memory access so as to prevent successive write access after read access, and the number of memory access cycles is reduced by changing the priority of memory access so as to prevent successive refresh after a write access request.

### DISCLOSURE OF THE INVENTION

In order to solve the problem, a memory controller of a first aspect of the present invention changes priority so as to make access to a different bank from memory access having been permitted immediately before by an arbitration circuit which arbitrates memory access from a plurality of blocks.

According to the first aspect of the present invention, the memory controller for controlling memory having a plurality of banks comprises: the arbitration circuit for arbitrating a memory access request for making access to the memory from the plurality of blocks, a command generation block for generating a memory command for the memory based on a control signal from the arbitration circuit, an address generation block which receives a memory address from the block permitted to access by the arbitration circuit and outputs the memory address to the memory, and a data latch block which latches write data from the block permitted to access by the arbitration circuit or read data from the memory and passes data between the memory and the block permitted to access, wherein the priority of memory access from the plurality of blocks is changed so as to make access to a different bank from memory access having been permitted by the arbitration circuit immediately before.

In the memory controller of the first aspect of the present invention, according to a second aspect of the present invention, the arbitration circuit comprises a request receiving block which receives a memory request and a memory address from the plurality of blocks, includes a bank decision unit for deciding whether access is made to the same bank based on the received memory address, and provides an instruction to generate the enabling signal, a memory access priority designating unit for designating the priority of memory access from the plurality of blocks, an identical bank priority designating unit for selecting a block to be subsequently permitted to access when a memory access request is made from the plurality of blocks to the same bank as immediately preceding access, an enabling signal generation block which is instructed by the request receiving block to generate the enabling signal and outputs the enabling signal to the block permitted to access the memory, and a control signal generation block which is instructed by the request receiving block to generate the control signal and generates each control signal.

In the memory controller of the first aspect of the present invention, according to a third aspect of the present invention, the arbitration circuit lowers the priority of memory access made from the block to the same bank as memory access having been permitted immediately before.

In the memory controller of the first aspect of the present invention, according to a fourth aspect of the present invention, the arbitration circuit lowers the priority of memory access made from the block to the same bank as memory access having been permitted immediately before.

In the memory controller of the first aspect of the present invention, according to a fifth aspect of the present invention, the arbitration circuit lowers the priority of memory access when the bank where memory access is permitted immediately before is the same as a subsequent memory access request.

In the memory controller of the second aspect of the present invention, according to a sixth aspect of the present invention, the memory access priority designating unit can be set from the outside and the priority of access from the plurality of blocks to the memory can be changed according to the setting of the memory access priority designating unit.

In the memory controller of the second aspect of the present invention, according to a seventh aspect of the present invention, the identical bank priority designating unit can be set from the outside and a block to be subsequently permitted to access the memory can be selected according to priority set by the identical bank priority designating unit when a memory access request is made from the plurality of blocks to the same bank as immediately preceding access.

In the memory controller of the first aspect of the present invention, according to an eighth aspect of the present invention, the memory is synchronous memory.

Further, in order to solve the problem, according to a memory controller of a ninth aspect of the present invention, when memory access is requested for each piece of block access data, the arbitration circuit changes the order of bank access data in the block data when a second-half bank where memory access is permitted by the arbitration circuit immediately before is the same as the first-half bank of a subsequent memory access request.

Moreover, when a second-half bank where memory access is permitted immediately before is the same as the first-half bank of a subsequent memory access request, the order of the bank access data in the block access data is changed, the block access data is read from the memory and is stored in the data latch block, the order is changed for each piece of the bank access data in the block access data, and the data latch block makes transfer to the block having performed memory access.

According to a ninth aspect of the present invention, a memory controller for controlling memory having a plurality of banks comprises: an arbitration circuit for arbitrating a memory access request for making access to the memory from a plurality of blocks, a command generation block for generating a memory command for the memory based on a control signal from the arbitration circuit, an address generation block which receives a memory address from the block permitted to access by the arbitration circuit and outputs the memory address to the memory, and a data latch block which latches write data from the block permitted to access by the arbitration circuit or read data from the memory and passes data between the memory and the block permitted to access, wherein bank access data is access data to the memory, the bank access data having a predetermined number of bytes for performing writing or reading on the same bank of the memory, block access data is a data unit constituted of two sets of the bank access data belonging to different banks, and when the plurality of blocks make a memory access request for each piece of the block access data, the arbitration circuit changes the order of memory access of the bank access data in the block access data when a second-half bank where memory access is permitted immediately before is the same as the first-half bank of a subsequent memory access request.

In the memory controller of the ninth aspect of the present invention, according to a tenth aspect of the present invention, the arbitration circuit comprises a request receiving block which receives a memory request and a memory address from the plurality of blocks, includes a bank decision unit for deciding, based on the received memory address, whether access is made to the same bank regarding a second-half bank where memory access has been permitted immediately before and the first-half bank of a subsequent memory access request, and provides an instruction to generate an enabling signal, a memory access priority designating unit for designating the priority of memory access from the plurality of blocks, an enabling signal generation block which is instructed by the request receiving block to generate the enabling signal and outputs the enabling signal to the block permitted to access the memory, and a control signal generation block which is instructed by the request receiving block to generate the control signal and generates each control signal.

In the memory controller of the ninth aspect of the present invention, according to an eleventh aspect of the present invention, the data latch block comprises a write data latch block which receives and latches write data from the plurality of blocks, a data change block which, based on a data latch control signal from the arbitration circuit, changes the order of bank access data outputted by the write data latch block, outputs the data as write data to the memory, changes the order of bank access data outputted by a read data latch block (described later), and outputs the data as read data to a block permitted to perform read access to the memory, and a read data latch block which receives and latches read data having been read from the memory.

In the memory controller of the ninth aspect of the present invention, according to a twelfth aspect of the present invention, when the second-half bank where memory access has been permitted immediately before is the same as the first-half bank of the subsequent memory access request, the arbitration circuit changes the order of the bank access data in the block access data, reads the block access data from the memory, and stores the data in the data latch block, and the data latch block changes the order of each piece of the bank access data in the block access data and transfers the data to the block having performed memory access.

In the memory controller of the tenth aspect of the present invention, according to a thirteenth aspect of the present invention, the memory access priority designating unit can be set from the outside and the priority of access from the plurality of blocks to the memory can be changed according to the setting of the memory access priority designating unit.

In the memory controller of the ninth aspect of the present invention, according to a fourteenth aspect of the present invention, the memory is synchronous memory.

Further, in order to solve the problem, according to a memory controller of a fifteenth aspect of the present invention, a wait cycle is provided by the command generation block when memory access is requested by the bank access data alone from the block permitted to access the memory.

According to a fifteenth aspect of the present invention, a memory controller for controlling memory having a plurality of banks comprises: an arbitration circuit for arbitrating a memory access request for making access to the memory from a plurality of blocks, a command generation block for generating a memory command for the memory based on a control signal from the arbitration circuit, an address generation block which receives a memory address from the block permitted to access by the arbitration circuit and outputs the memory address to the memory, and a data latch block which latches write data from the block permitted to access by the arbitration circuit or read data from the memory and passes data between the memory and the block permitted to access, wherein when bank access data is access data to the memory, which access data having a predetermined number of bytes for performing writing or reading on the same bank of the memory, and block access data is a data unit constituted of two sets of the bank access data belonging to different banks, the arbitration circuit instructs the command generation block to provide a wait cycle when a memory access request is made by the bank access data alone from the block permitted to access the memory.

In the memory controller of the fifteenth aspect of the present invention, according to a sixteenth aspect of the present invention, the arbitration circuit comprises a request receiving block which receives memory requests from the plurality of blocks, includes a data unit decision unit for deciding a data unit of requested memory access based on the received memory request, and provides an instruction to generate an enabling signal, a memory access priority designating unit for designating the priority of memory access from the plurality of blocks, a wait cycle designating unit for designating the number of wait cycles provided when memory access is requested from the plurality of blocks by the bank access data alone, an enabling signal generation block which is instructed by the request receiving block to generate the enabling signal and outputs the enabling signal to the block permitted to access the memory, and a control signal generation block which is instructed by the request receiving block to generate the control signal and generates each control signal.

In the memory controller of the sixteenth aspect of the present invention, according to a seventeenth aspect of the present invention, the memory access priority designating unit can be set from the outside and the priority of access from the plurality of blocks to the memory can be changed according to the setting of the memory access priority designating unit.

In the memory controller of the sixteenth aspect of the present invention, according to an eighteenth aspect of the present invention, the wait cycle designating unit can be set from the outside and the number of wait cycles provided by the command generation block can be changed according to the setting of the wait cycle designating unit.

In the memory controller of the fifteenth aspect of the present invention, according to a nineteenth aspect of the present invention, the memory is synchronous memory.

Further, in order to solve the problem, according to a memory controller of a twelfth aspect of the present invention, when memory access permitted by an arbitration circuit is read access, the priority of memory access requests from a plurality of blocks is changed so as to successively perform read access.

According to the twentieth aspect of the present invention, the memory controller for controlling memory having a plurality of banks comprises: the arbitration circuit for arbitrating a memory access request for making access to the memory from the plurality of blocks, a command generation block for generating a memory command for the memory based on a control signal from the arbitration circuit, an address generation block which receives a memory address from the block permitted to access by the arbitration circuit and outputs the memory address to the memory, and a data latch block which latches write data from the block permitted to access by the arbitration circuit or read data from the memory and passes data between the memory and the block permitted to access, wherein when memory access permitted by the arbitration circuit immediately before is read access, the priority of memory access requests from the plurality of blocks is changed so as to successively perform read access.

In the memory controller of the twentieth aspect of the present invention, according to a twenty first aspect of the present invention, the arbitration circuit comprises a request receiving block which receives memory requests from the plurality of blocks, includes an access request decision unit for deciding the kind of requested memory access based on the received memory requests, and provides an instruction to generate an enabling signal, a memory access priority designating unit for designating the priority of memory access from the plurality of blocks, a read access priority designating unit for selecting a block to be subsequently permitted to perform read access when memory access permitted immediately before is read access, an enabling signal generation block which is instructed by the request receiving block to generate the enabling signal and outputs the enabling signal to the block permitted to access the memory, and a control signal generation block which is instructed by the request receiving block to generate the control signal and generates each control signal.

In the memory controller of the twentieth aspect of the present invention, according to a twenty second aspect of the present invention, the arbitration circuit increases the priority of read access when memory access permitted immediately before is read access.

In the memory controller of the twentieth aspect of the present invention, according to a twenty third aspect of the present invention, the arbitration circuit increases the priority of read access when memory access permitted immediately before is read access and a subsequent memory access is made for read access.

In the memory controller of the twentieth aspect of the present invention, according to a twenty fourth aspect of the present invention, the memory access priority designating unit can be set from the outside and the priority of access from the plurality of blocks to the memory can be changed according to the setting of the memory access priority designating unit.

In the memory controller of the twentieth aspect of the present invention, according to a twenty fifth aspect of the present invention, the read access priority designating unit can be set from the outside and a block to be subsequently permitted to perform read access to the memory can be selected according to the priority set by the read access priority designating unit when memory access permitted by the arbitration circuit immediately before is read access.

In the memory controller of the twentieth aspect of the present invention, according to a twenty sixth aspect of the present invention, the memory is synchronous memory.

Further, in order to solve the problem, a memory controller according to a twenty seventh aspect of the present invention changes the priority of a refresh request from a refresh request block when memory access permitted immediately before is write access.

According to a twenty seventh aspect of the present invention, a memory controller for controlling memory having a plurality of banks comprises: a refresh request block for requesting refresh at regular intervals to store the internal data of the memory, an arbitration circuit for arbitrating a memory access request for accessing the memory from a plurality of blocks and a refresh request from the refresh request block, a command generation block for generating a memory command for the memory based on a control signal from the arbitration circuit, an address generation block which receives a memory address from the block permitted to access by the arbitration circuit and outputs the memory address to the memory, and a data latch block which latches write data from the block permitted to access by the arbitration circuit or read data from the memory and passes data between the memory and the block permitted to access, wherein when memory access permitted by the arbitration circuit immediately before is write access, the priority of a refresh request from the refresh request block is changed.

In the memory controller of the twenty seventh aspect of the present invention, according to a twenty eighth aspect of the present invention, the arbitration circuit comprises a request receiving block which receives the refresh request from the refresh request block and the memory request from the plurality of blocks, includes an access request decision unit for deciding the kind of requested memory access based on the received refresh request and memory request, and provides an instruction to generate an enabling signal, a memory access priority designating unit for designating the priority of memory access from the plurality of blocks, a write access priority designating unit for selecting a block to be subsequently permitted to perform read access when the refresh request is outputted from the refresh request block and memory access permitted by the arbitration circuit immediately before is write access, an enabling signal generation block which is instructed by the request receiving block to generate the enabling signal and outputs the enabling signal to the block permitted to access the memory, and a control signal generation block which is instructed by the request receiving block to generate the control signal and generates each control signal.

In the memory controller of the twenty seventh aspect of the present invention, according to a twenty ninth aspect of the present invention, the arbitration circuit lowers the priority of a refresh request when memory access permitted immediately before is write access.

In the memory controller of the twenty seventh aspect of the present invention, according to a thirtieth aspect of the present invention, the arbitration circuit lowers the priority of a refresh request when memory access permitted immediately before is write access and a subsequent memory access request includes a refresh request.

In the memory controller of the twenty eighth aspect of the present invention, according to a thirty first aspect of the present invention, the memory access priority designating unit can be set from the outside and the priority of access from the plurality of blocks to the memory can be changed according to the setting of the memory access priority designating unit.

In the memory controller of the twenty eighth aspect of the present invention, according to a thirty second aspect of the present invention, the write access priority order designating unit can be set from the outside and a block to be subsequently permitted to access the memory can be selected according to priority set by the write access priority order designating unit when a refresh request is outputted from the refresh request block and memory access permitted by the arbitration circuit immediately before is write access.

In the memory controller of the twenty seventh aspect of the present invention, according to a thirty third aspect of the present invention, the memory is synchronous memory.

According to a thirty fourth aspect of the present invention, a memory controller for controlling memory having a plurality of banks comprises: an arbitration circuit for arbitrating a memory access request for making access to the memory from a plurality of blocks, a command generation block for generating a memory command for the memory based on a control signal from the arbitration circuit, an address generation block which receives a memory address from the block permitted to access by the arbitration circuit and outputs the memory address to the memory, a data latch block which latches write data from the block permitted to access by the arbitration circuit or read data from the memory and passes data between the memory and the block permitted to access, wherein the arbitration circuit designates an arbitrating method for changing the priority of memory access from the plurality of blocks when the memory access request from the plurality of blocks is made to the same bank as immediately preceding access and memory access permitted by the arbitration circuit immediately before is read access.

In the memory controller of the thirty fourth aspect of the present invention, according to a thirty fifth aspect of the present invention, the arbitration circuit comprises a bank decision unit which receives a memory address from the plurality of blocks and decides whether access is made to the same bank or not based on the received memory address, an access request decision unit which receives memory requests from the plurality of blocks and decides the kind of requested memory access based on the received memory requests, a request receiving block which includes the bank decision unit and the access request decision unit and provides an instruction to generate an enabling signal, a memory access priority designating unit for designating the priority of memory access from the plurality of blocks, an arbitrating method designating unit for designating an arbitrating method for changing the priority of memory access when the memory access request from the plurality of block is made to the same bank as immediately preceding access and memory access permitted by the arbitration circuit immediately before is read access, an identical bank priority designating unit for selecting a block to be subsequently permitted to access when the arbitrating method designating unit is set so as to place higher priority on a bank, a read access priority designating unit for selecting a block to be subsequently permitted to perform read access when the arbitrating method designating unit is set so as to place higher priority on access, an enabling signal generation block which is instructed by the request receiving block to generate the enabling signal and outputs the enabling signal to the block permitted to access the memory, and a control signal generation block which is instructed by the request receiving block to generate the control signal and generates each control signal.

In the memory controller of the thirty fifth aspect of the present invention, according to a thirty sixth aspect of the present invention, the memory access priority designating unit can be set from the outside and the priority of access from the plurality of blocks to the memory can be changed according to the setting of the memory access priority designating unit.

In the memory controller of the thirty fifth aspect of the present invention, according to a thirty seventh aspect of the present invention, the arbitrating method designating unit can be set from the outside and the arbitrating method of memory access from the plurality of blocks can be changed according to the setting of the arbitrating method designating unit.

In the memory controller of the thirty fifth aspect of the present invention, according to a thirty eighth aspect of the present invention, the identical bank priority designating unit can be set from the outside and a block to be subsequently permitted to access to the memory can be selected according to priority set by the identical bank priority designating unit when the arbitrating method designating unit is set so as to place higher priority on a bank and a memory access request is made from the plurality of blocks to the same bank as immediately preceding access.

In the memory controller of the thirty fifth aspect of the present invention, according to a thirty ninth aspect of the present invention, the read access priority designating unit can be set from the outside and a block to be subsequently permitted to perform read access to the memory can be selected according to priority set by the read access priority designating unit when the arbitrating method designating unit is set so as to place higher priority on access and memory access permitted by the arbitration circuit immediately before is read access.

In the memory controller of the thirty fourth aspect of the present invention, according to a fortieth aspect of the present invention, the memory is synchronous memory.

As described above, according to the memory controller of the present invention, it is possible to eliminate a wait cycle disabling access to the memory and improve processing time when access is successively made to the same bank as memory access having been permitted by the arbitration circuit. Further, the plurality of blocks for generating a memory address can generate a memory address regardless of a bank where memory access is permitted immediately before.

Moreover, in response to a memory access request for each piece of block access data constituted of two sets of bank access data belonging to different banks, it is possible to eliminate a wait cycle disabling access to the memory and improve processing time when a second-half bank where memory access is permitted immediately before is the same as the first-half bank of a subsequent memory access request. Further, the plurality of blocks for generating a memory address can generate a memory address regardless of an immediately preceding bank.

Moreover, block access data read from the memory is outputted in order of memory access requested by the blocks, so that the plurality of blocks for generating a memory address can receive, regardless of a bank, block access data having been read from the memory.

Further, when the arbitration circuit permits a memory access request from a block which makes a memory access request by means of the bank access data alone, a wait cycle is provided by the command generation block. Thus, it is possible to achieve memory access without being affected by the bank of memory access permitted immediately before and reduce necessary circuits because memory access is performed by the bank access data alone.

Besides, when memory access permitted by the arbitration circuit immediately before is read access, it is possible to eliminate a wait cycle, which occurs when a subsequent memory access request is made for read access and disables access to the memory, and improve processing time.

Moreover, when memory access permitted by the arbitration circuit is write access, it is possible to eliminate a wait cycle, which occurs when a subsequent memory access request is a refresh request and disables access to the memory, and improve processing time.

### BRIEF DESCRIPTION OF THE DRAWINGS

FIG. 1 is a block diagram showing a memory controller according to Embodiment 1 of the present invention;

FIG. 2 is a timing chart showing the main signals of the memory controller according to Embodiment 1 of the present invention;

FIG. 3 is a timing chart showing the main signals of a memory controller according to Embodiment 2 of the present invention;

FIG. 4 is a timing chart showing the main signals of a memory controller according to Embodiment 3 of the present invention;

FIG. 5 is a timing chart showing the main signals of a memory controller according to Embodiment 4 of the present invention;

FIG. 6 is a block diagram showing a memory controller according to Embodiment 5 of the present invention;

FIG. 7 is a timing chart showing the main signals of the memory controller according to Embodiment 5 of the present invention;

FIG. 8 shows an arbitration circuit of Embodiment 1;

FIG. 9 is a timing chart for selecting, when the same bank is accessed successively, a block to be subsequently permitted to access according to Embodiment 1 of the present invention;

FIG. 10 is a block diagram showing an arbitration circuit 101 according to Embodiment 2 of the present invention;

FIG. 11 is a data latch block 104 according to Embodiment 2 of the present invention;

FIG. 12 is a block diagram showing an arbitration circuit according to Embodiment 3 of the present invention;

FIG. 13 is a block diagram showing an arbitration circuit according to Embodiment 4 of the present invention;

FIG. 14 is a timing chart for subsequently permitting read access when memory access permitted by the arbitration circuit 101 immediately before is read access, according to Embodiment 4 of the present invention;

FIG. 15 is a block diagram showing an arbitration circuit according to Embodiment 5 of the present invention;

FIG. 16 is a timing chart for subsequently permitting read access when memory access permitted by the arbitration circuit 101 immediately before is write access, according to Embodiment 5 of the present invention;

FIG. 17 is a block diagram showing an arbitration circuit according to Embodiment 6 of the present invention;

FIG. 18 is a block diagram showing the configuration of a conventional memory controller; and

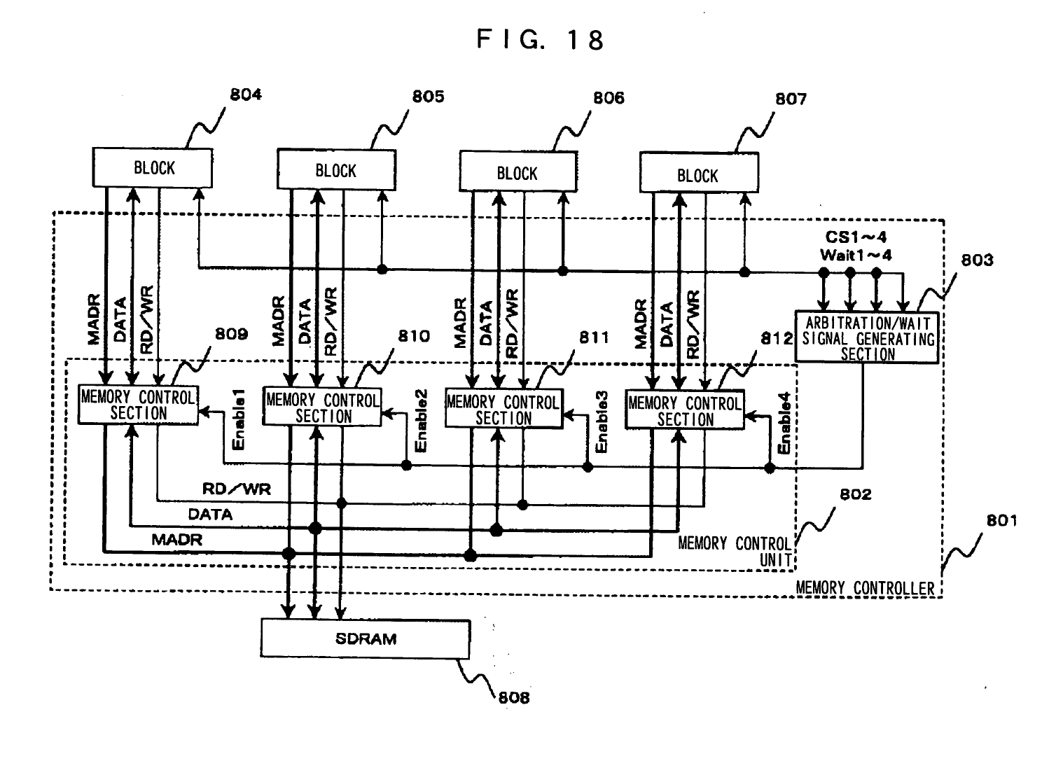

FIG. 19 is a timing chart showing the main signals of the conventional memory controller.

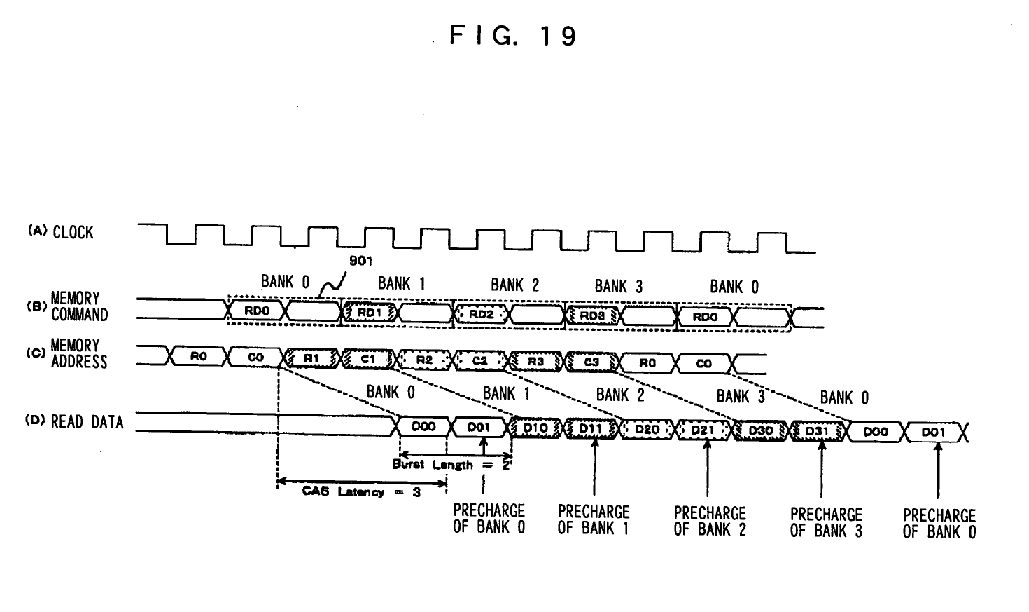

### BEST MODE FOR CARRYING OUT THE INVENTION

### Embodiment 1

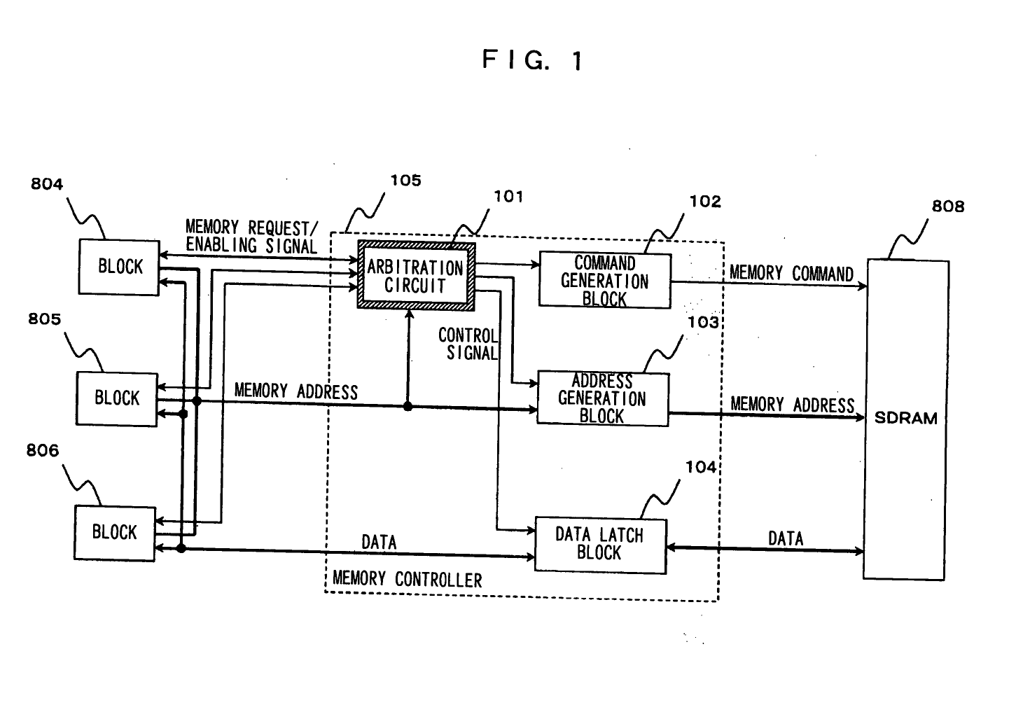

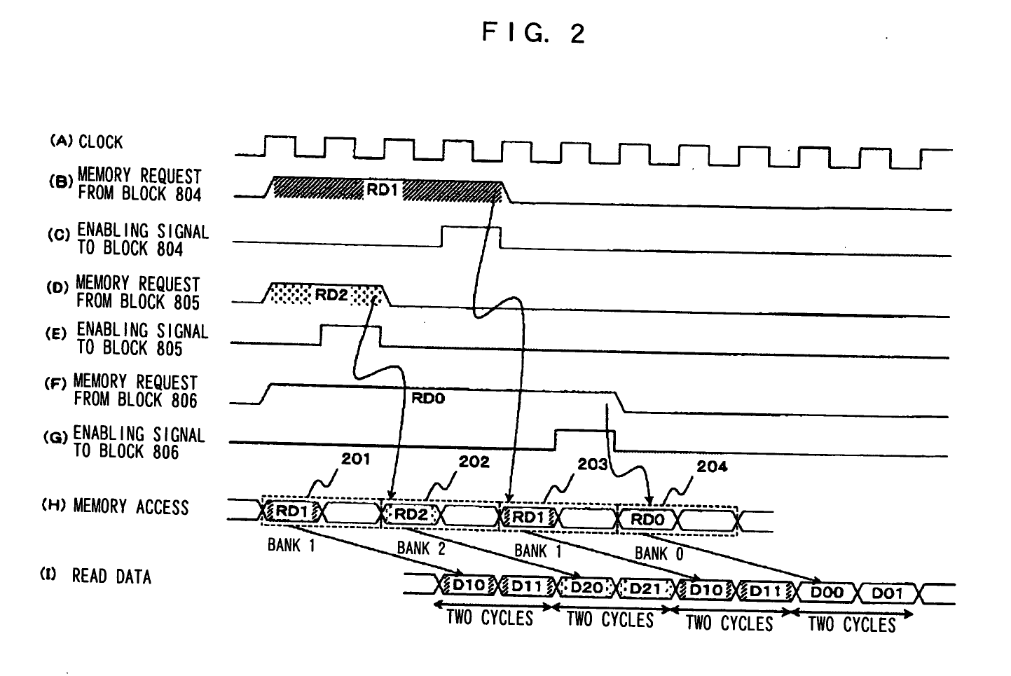

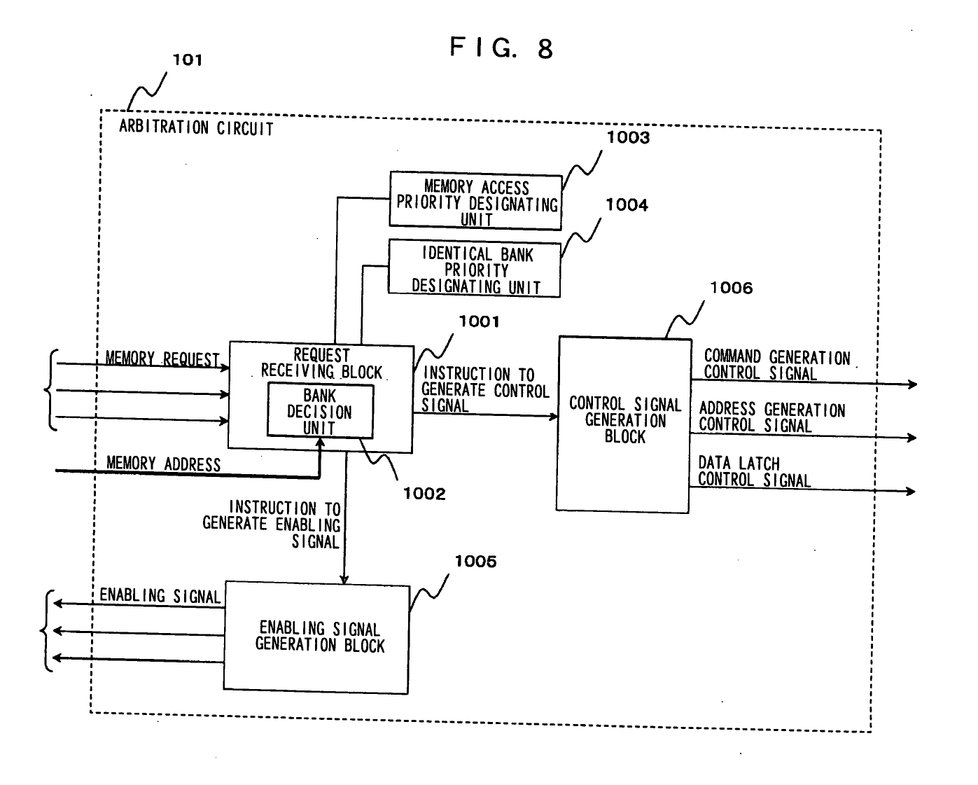

Referring to FIGS. 1, 2, 8, and 9, the following will describe Embodiments 1 to 8 of the present invention. FIG. 1 is a block diagram showing a memory controller of Embodiment 1. FIG. 2 is a timing chart of main signals shown in FIG. 1. FIG. 8 is a block diagram showing an arbitration circuit of Embodiment 1.

As shown in FIG. 1, a memory controller 105 is constituted of an arbitration circuit 101 for arbitrating memory access requests from a plurality of blocks 804, 805, and 806 which access SDRAM 808, a command generation block 102 for generating a memory command to the SDRAM 808, an address generation block 103 which receives a memory address from the block permitted to access by the arbitration circuit 101 and outputs the address to the SDRAM 808, and a data latch block 104 which latches writing data from the block permitted to access by the arbitration circuit 101 or reading data from the SDRAM 808 and passes the data between the block permitted to access and the SDRAM 808.

As shown in FIG. 8, the arbitration circuit 101 is constituted of a request receiving block 1001 which receives memory requests and a memory address from the plurality of blocks 804, 805, and 806, includes a bank decision unit 1002 for deciding whether access is made to the same bank or not based on the received memory address, and provides an instruction to generate an enabling signal, a memory access priority designating unit 1003 for designating the priority of memory access from the plurality of blocks 804, 805, and 806, an identical bank priority designating unit 1004 for selecting a block to be subsequently accessed when a memory access request is made from the plurality of blocks 804, 805, and 806 to the same bank as immediately preceding access, an enabling signal generation block 1005 which is instructed by the request receiving block 1001 to generate an enabling signal and outputs the enabling signal to the block permitted to access the SDRAM 808, and a control signal generation block 1006 which is instructed by the request receiving block 1001 to generate a control signal and generates a command generation control signal, an address generation control signal, and a data latch control signal.

In FIG. 2,
(A) denotes a clock for operating the SDRAM 808,
(B) denotes a memory request outputted from the block 804 to the arbitration circuit 101,
(C) denotes a memory access enabling signal returned from the arbitration circuit 101 to the block 804,
(D) denotes a memory request outputted from the block 805 to the arbitration circuit 101,
(E) denotes a memory access enabling signal returned from the arbitration circuit 101 to the block 805,
(F) denotes a memory request outputted from the block 806 to the arbitration circuit 101,
(G) denotes a memory access enabling signal returned from the arbitration circuit 101 to the block 806,
(H) denotes memory access performed on the SDRAM 808 by the memory controller 105, and
(I) denotes read data having been read from the SDRAM 808.

Reference numeral 201 denotes memory read access to a bank 1 which is accessed by the memory controller 105,

reference numeral 202 denotes memory read access from the block 805 to a bank 2,

reference numeral 203 denotes memory read access from the block 804 to the bank 1, and

reference numeral 204 denotes memory read access from the block 806 to a bank 0.

The blocks 804, 805, and 806 include, for example, a CPU and an error correction block. Data is transferred between a host computer and a microcomputer via the SDRAM 808 and erroneous data is corrected by the error correction block. Further, from the blocks 804, 805, and 806, a memory access request is made to the same bank of the SDRAM 808 for each piece of bank access data, which includes writing or reading data of 8 bytes.

First, the following will describe that a bank where memory access is permitted by the arbitration circuit 101 immediately before is the same as the subsequent memory access request.

The following will describe the operations of the memory controller 105 when the block 804 reads data from the SDRAM 808, on the assumption that the mode setting of the SDRAM 808 is “CAS latency”=“3” and “burst length”=“2” and the memory access priority designating unit 1003 places higher priority to the SDRAM 808 on the blocks 804, 805, and 806 in this order.

When the block 804 accesses the SDRAM 808, the block 804 passes a memory address, data, and a control signal via the memory controller 105. In response to the memory request (FIG. 2(B)) outputted from the block 804 to the arbitration circuit 101, the arbitration circuit 101 returns the memory access enabling signal (FIG. 2(C)) to the block 804 when no other block outputs a memory request to the SDRAM 808. When another block (blocks 805 and 806) outputs the memory request (FIGS. 2(D) and 2(F)) concurrently with the memory request of the block 804, the memory access enabling signal is returned to the block having higher priority according to the priority for making access to the SDRAM 808.

It is assumed that the memory controller 105 accesses the bank 1 of the SDRAM 808 (FIG. 2(H) 201), the memory read request (FIG. 2(B)) is outputted from the block 804 to the bank 1 of the SDRAM 808, the memory read request (FIG. 2(D)) is simultaneously outputted from the block 805 to the bank 2, and the memory read request (FIG. 2(F)) is simultaneously outputted from the block 806 to the bank 0. When the memory read request (FIG. 2(B)) is outputted from the block 804 to the bank 1 of the SDRAM 808, the arbitration circuit 101 receives a memory request and a memory address in the request receiving block 1001, decides, in the bank decision unit 1002, that the request is a memory access request made to the same bank as the memory read access (FIG. 2(H) 201) to the bank 1 which is accessed by the memory controller 105, and the arbitration circuit 101 instructs the enabling signal generation block 1005 to generate an enabling signal for the block 805 having the second priority. The request receiving block 1001 lowers the priority of the memory read request to the bank 1 that is outputted from the block 804, and instructs the control signal generation block 1006 to generate a control signal for the memory access request of the block 805 having the second highest priority. The enabling signal generation block 1005 returns the memory access enabling signal (FIG. 2(E)) to the block 805 (priority change).

The control signal generation block 1006 is instructed to generate a control signal from the request receiving block 1001 and generates a command generation control signal, an address generation control signal, and a data latch control signal.

Based on the address generation control signal outputted from the arbitration circuit 101, the address generation block 103 receives a memory address from the block 805 permitted to access and outputs the memory address to the SDRAM 808.

Based on the command generation control signal outputted from the arbitration circuit 101, the command generation block 102 generates a memory command such as RAS (Row Address Strobe) and CAS (Column Adderess Strobe), outputs the memory command to the SDRAM 808, and performs the memory read access 202 from the block 805 to the bank 2. Data read from the SDRAM 808 is captured by the data latch block 104 and is outputted to the block 805.

Based on the memory command outputted from the command generation block 102 and the memory address outputted from the address generation block 103, the SDRAM 808 reads data D20 and D21 therefrom. The data D21 has an address subsequent to that of the data D20, which means that two-word data can be outputted by means of one address input (“burst length”=“2”). Each of the banks is automatically precharged when the final data, that is, the data D21 and so on are outputted during the two-word output. The bank 0, bank 1, and bank 3 are precharged in a like manner. When the memory read access 202 from the block 805 to the bank 2 is completed, the memory read access 203 is made from the block 804 to the bank 1 according to the priority of memory access, and then, memory read access 204 is made from the block 806 to the bank 0.

The following will describe the case where lower priority is given to a block accessing to a bank where memory access has been permitted by the arbitration circuit 101 immediately before.

Hereinafter, it is assumed that the mode setting of the SDRAM 808 is “CAS latency”=“3” and “burst length”=“2”, higher priority to the SDRAM 808 is given to the blocks 804, 805, and 806 in this order in the memory access priority designating unit 1003, and memory access requests are outputted from the block 804 to the bank 1, from the block 805 to the bank 2, and from the block 806 to the bank 0. When access permitted by the arbitration circuit 101 immediately before is memory read access to the bank 1 and the memory controller 105 performs memory read access (FIG. 2(H) 201) to the bank 1, the bank decision unit 1002 lowers the memory access priority of the block 804, which outputs an access request to the bank 1, when the immediately preceding memory access is permitted.

When the memory read request (FIG. 2(B)) is outputted from the block 804 to the bank 1 of the SDRAM 808, the memory read request (FIG. 2(D)) is simultaneously outputted from the block 805 to the bank 2, and the memory read request (FIG. 2(F)) is simultaneously outputted from the block 806 to the bank 0, the request receiving block 1001 instructs the enabling signal generation block 1005 to generate an enabling signal for the block 805 and instructs the control signal generation block 1006 to generate a control signal for the memory access request of the block 805. The enabling signal generation block 1005 returns the memory access enabling signal (FIG. 2(E)) to the block 805 (priority change).

The control signal generation block 1006 is instructed by the request receiving block 1001 to generate a control signal and generates the command generation control signal, the address generation control signal, and the data latch control signal.

Regarding the command generation block 102, the address generation block 103, and the data latch block 104, and in and after the memory read access 202 from the block 805 to the bank 2, the same operations are performed as in the following case: a bank where memory access is permitted by the arbitration circuit 101 immediately before is the same as a subsequent memory access request. Thus, the explanation of the operations is omitted.

In the following description, higher priority is given to memory access from a block to a bank different from that of memory access having been permitted by the arbitration circuit 101 immediately before.

Hereinafter, it is assumed that the mode setting of the SDRAM 808 is “CAS latency”=“3” and “burst length”=“2”, higher priority to the SDRAM 808 is given to the blocks 804, 805, and 806 in this order in the memory access priority designating unit 1003, the block 804 outputs a memory access request to the bank 1, the block 805 outputs a memory access request to the bank 2, and the block 806 outputs a memory access request to the bank 0.

When access permitted by the arbitration circuit 101 immediately before is memory read access to the bank 1 and the memory controller 105 performs memory read access (FIG. 2(H) 201) on the bank 1, the bank decision unit 1002 increases the priority of the memory access to the block 805, which has the second highest priority, so that access is made to a different bank when the immediately preceding memory access is permitted.

When the memory read request (FIG. 2(B)) is outputted from the block 804 to the bank 1 of the SDRAM 808, the memory read request (FIG. 2(D)) is simultaneously outputted from the block 805 to the bank 2, and the memory read request (FIG. 2(F)) is simultaneously outputted from the block 806 to the bank 0, the request receiving block 1001 instructs the enabling signal generation block 1005 to generate an enabling signal for the block 805. Moreover, the request receiving block 1001 instructs the control signal generation block 1006 to generate a control signal for the memory access of the block 805. The enabling signal generation block 1005 returns the memory access enabling signal (FIG. 2(E)) to the block 805 (priority change).

The control signal generation block 1006 is instructed by the request receiving block 1001 to generate a control signal and generates the command generation control signal, the address generation control signal, and the data latch control signal.

Regarding the command generation block 102, the address generation block 103, and the data latch block 104, and in and after the memory read access 202 from the block 805 to the bank 2, the same operations are performed as in the following case: a bank where memory access is permitted immediately before is the same as a subsequent memory access request. Thus, the explanation of the operations is omitted.

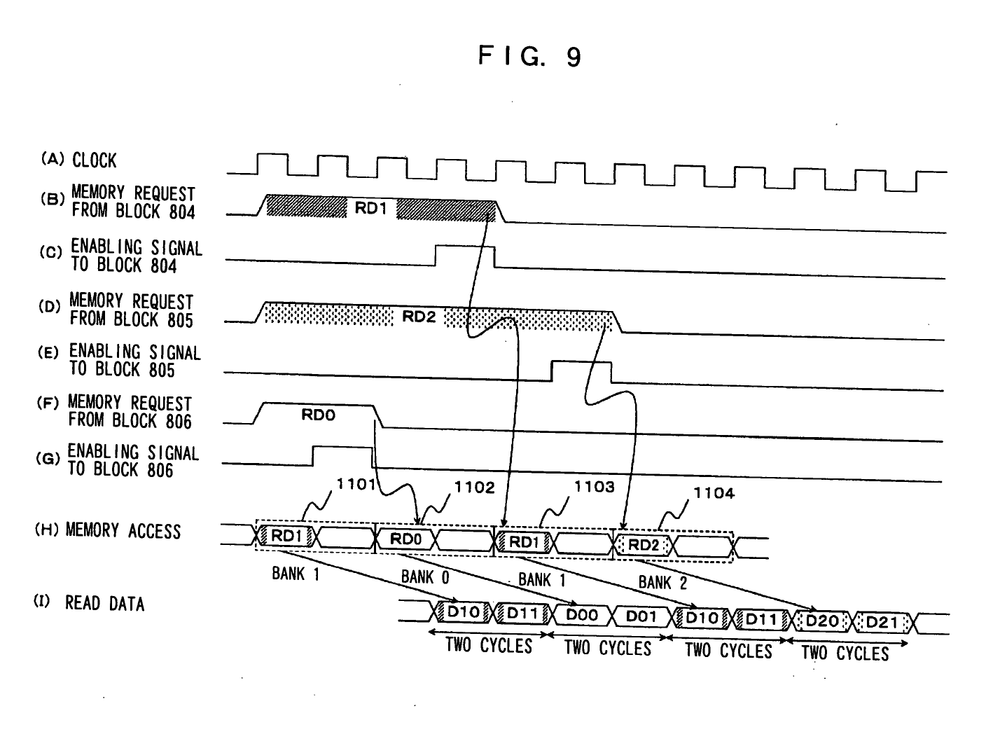

Referring to FIG. 9, the following will describe that when an access request is made from a block to the same bank as memory access having been permitted by the arbitration circuit 101 immediately before, a block subsequently permitted to access is selected. FIG. 9 is a timing chart for selecting a block subsequently permitted to access when the same bank is requested successively.

In FIG. 9,
(A) denotes a clock for operating the SDRAM 808,
(B) denotes a memory request outputted from the block 804 to the arbitration circuit 101,
(C) denotes a memory access enabling signal returned from the arbitration circuit 101 to the block 804,
(D) denotes a memory request outputted from the block 805 to the arbitration circuit 101,
(E) denotes a memory access enabling signal returned from the arbitration circuit 101 to the block 805,
(F) denotes a memory request outputted from the block 806 to the arbitration circuit 101,
(G) denotes a memory access enabling signal returned from the arbitration circuit 101 to the block 806,
(H) denotes memory access performed on the SDRAM 808 by the memory controller 105, and
(I) denotes read data having been read from the SDRAM 808.

Reference numeral 1101 denotes memory read access to the bank 1 which is accessed by the memory controller 105,

reference numeral 1102 denotes memory read access from the block 806 to the bank 0,

reference numeral 1103 denotes memory read access from the block 804 to the bank 1, and

reference numeral 1104 denotes memory read access from the block 805 to the bank 2.

Hereinafter, it is assumed that the mode setting of the SDRAM 808 is “CAS latency”=“3” and “burst length”=“2”, higher priority to the SDRAM 808 is given to the blocks 804, 805, and 806 in this order in the memory access priority designating unit 1003. When memory access is made to the same bank, higher priority is given to the blocks 806, 805, and 804 in this order in the identical bank priority designating unit 1004. Further, it is assumed that memory access requests are outputted from the block 804 to the bank 1, from the block 805 to the bank 2, and from the block 806 to the bank 0.

In the case where access permitted by the arbitration circuit 101 immediately before is memory read access to the bank 1 and the memory controller 105 makes memory read access to the bank 1 (FIG. 9(H) 1101), when the memory read request (FIG. 9(B)) is outputted from the block 804 to the bank 1 of the SDRAM 808, the arbitration circuit 101 receives the memory request and memory address in the request receiving block 1001, decides that, in the bank decision unit 1002, a memory access request is made to the same bank as the memory read access (FIG. 2(H) 201) to the bank 1, which is accessed by the memory controller 105. The arbitration circuit 101 instructs the enabling signal generation block 1005 to generate an enabling signal for the block 806, which has the highest priority, according to the setting of the identical bank priority designating unit 1004, and instructs the control signal generation block 1006 to generate a control signal for the memory access request of the block 806. The enabling signal generation block 1005 returns the memory access enabling signal (FIG. 9(G)) to the block 806 (priority change for the same bank).

The control signal generation block 1006 is instructed by the request receiving block 1001 to generate a control signal and generates the command generation control signal, the address generation control signal, and the data latch control signal.

Based on the address generation control signal outputted from the arbitration circuit 101, the address generation block 103 receives a memory address from the block 806 permitted to access and outputs the memory address to the SDRAM 808. Based on the command generation control signal outputted from the arbitration circuit 101, the command generation block 102 generates a memory command such as RAS and CAS, outputs the memory command to the SDRAM 808, and performs the memory read access 1102 from the block 806 to the bank 0.

When the memory read access 1102 from the block 806 to the bank 0 is completed, the memory read access 1103 from the block 804 to the bank 1 is performed, and then, the memory read access 1104 from the block 805 to the bank 2 is performed.

With this configuration, when a bank accessed in the SDRAM 808 by the memory controller 105 is the same as the target of a memory access request from a block subsequently making access, the arbitration circuit 101 lowers the priority of the block which outputs memory access to the same bank or increases the priority of the block which outputs a memory access request to a different bank, so that access can be successively made to different banks. Thus, it is possible to eliminate a wait cycle disabling access to the SDRAM 808 and improve processing time.

Further, the plurality of blocks for generating a memory address can generate a memory address regardless of a bank accessed by the memory controller.

Embodiment 1 described as an example the case where the SDRAM 808 is set at “burst length”=“2”. The same effect can be obtained also by setting, e.g., “burst length”=“4”, “8”, and other values.

Moreover, Embodiment 1 described as an example the case where the SDRAM 808 is set at “CAS latency”=“3”. The same effect can be obtained also by setting, e.g., “CAS latency”=“2” and other values.

Embodiment 1 described an example where higher priority to the SDRAM 808 is given to the blocks 804, 805, and 806 in this order. The memory access priority designating unit 1003 may be set from the outside to change the priority of the blocks 804, 805, and 806. Also in this case, the same effect can be obtained as Embodiment 1.

Further, Embodiment 1 described an example where higher priority is given to the blocks 806, 805, and 804 in this order when memory access is made to the same bank. The identical bank priority designating unit 1004 maybe set from the outside to change the priority of the blocks 804, 805, and 806. Also in this case, the same effect can be obtained.

Embodiment 1 described an example where memory is the SDRAM 808. The same effect can be obtained by other kinds of synchronous memory as well as SDRAM.

### Embodiment 2

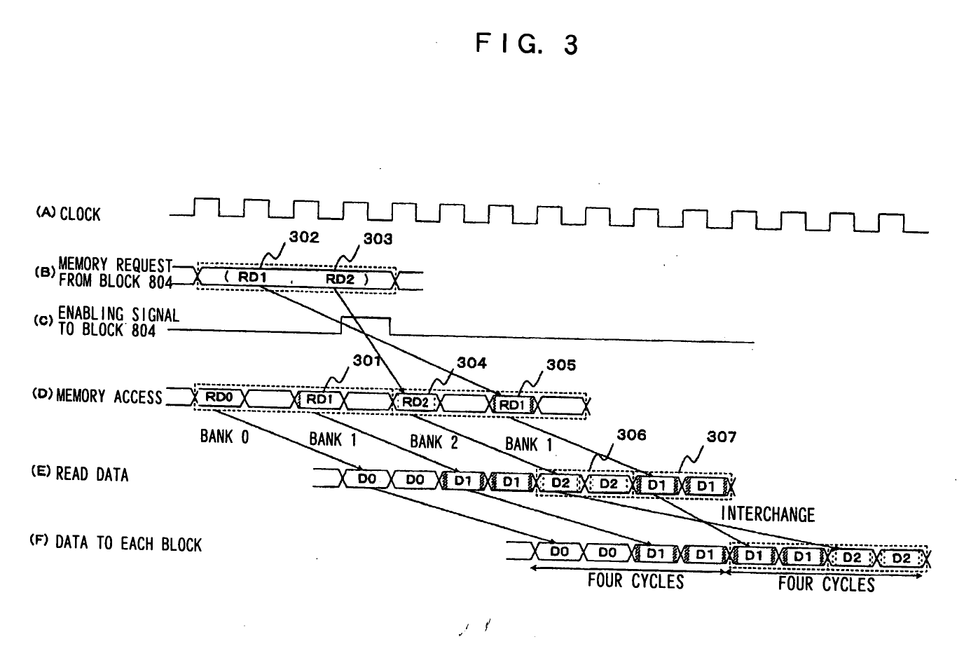

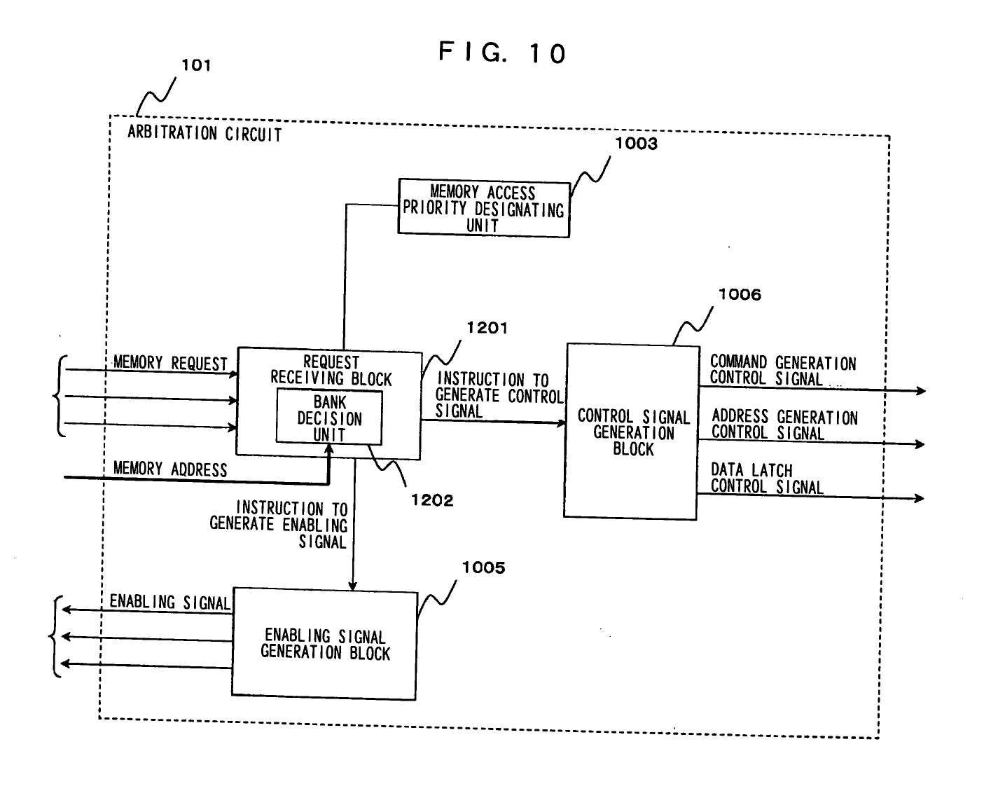

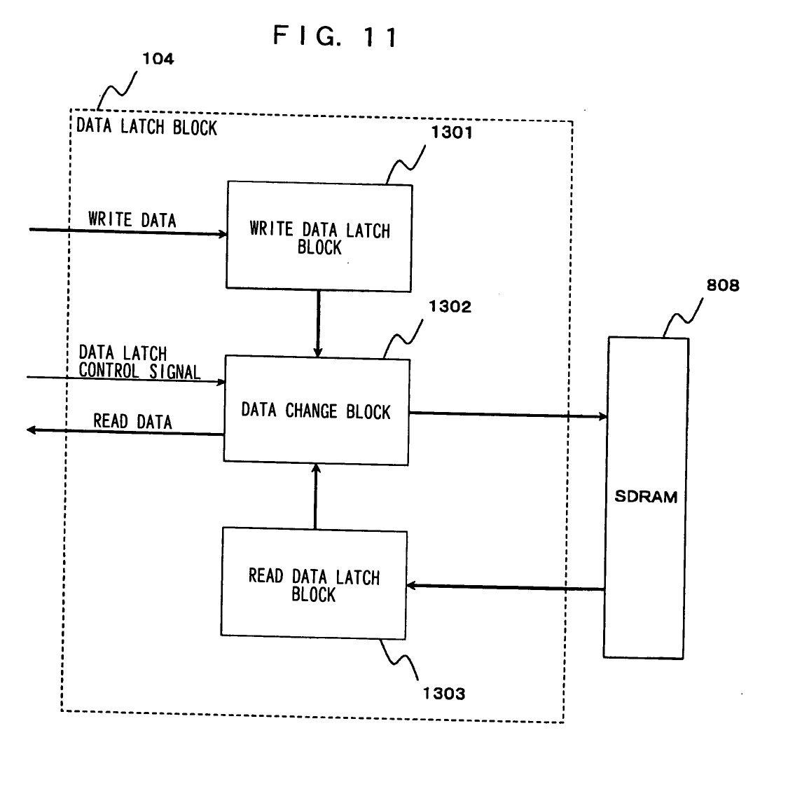

Referring to FIGS. 1, 3, 10, and 11, the following will describe Embodiments 9 to 14 of the present invention. FIG. 3 is a timing chart showing the main signals of Embodiment 2. FIG. 10 is a block diagram showing an arbitration circuit 101 of Embodiment 2. FIG. 11 is a block diagram showing a data latch block 104 of Embodiment 2.

A memory controller 105 is identical in configuration to Embodiment 1 (FIG. 1). The same figure numbers are used and the explanation of the configuration is omitted.

As shown in FIGS. 1 and 10, the arbitration circuit 101 is constituted of a request receiving block 1201 which receives memory requests and a memory address from a plurality of blocks 804, 805, and 806, includes a bank decision unit 1202 for deciding, based on the received memory address, whether access is made to the same bank regarding a second-half bank where memory access has been permitted immediately before and a first-half bank of a subsequent memory access request, and provides an instruction to generate an enabling signal, a memory access priority designating unit 1003 for designating the priority of memory access from the plurality of blocks 804, 805, and 806, an enabling signal generation block 1005 which is instructed by the request receiving block 1001 to generate an enabling signal and outputs the enabling signal to the block permitted to access the SDRAM 808, and a control signal generation block 1006 which is instructed by the request receiving block 1001 to generate a control signal and generates a command generation control signal, an address generation control signal, and a data latch control signal.

As shown in FIGS. 1 and 11, the data latch block 104 is constituted of a write data latch block 1301 which receives and latches write data from the plurality of blocks 804, 805, and 806, a data change block 1302 which, based on the data latch control signal from the arbitration circuit 101, changes the order of bank access data outputted by the write data latch block 1301, outputs the data as write data to the memory, changes the order of bank access data outputted by a read data latch block 1303 (described later), and outputs the data as read data to the block permitted to perform read access to the memory, and a read data latch block 1303 which receives and latches read data having been read from the SDRAM 808.

In FIG. 3,
(A) denotes a clock for operating the SDRAM 808,
(B) denotes a memory request outputted from the block 804 to the arbitration circuit 101,
(C) denotes a memory access enabling signal returned from the arbitration circuit 101 to the block 804,
(D) denotes memory access performed on the SDRAM 808 by the memory controller 105,
(E) denotes read data having been read from the SDRAM 808, and
(F) denotes data transferred to each block.

Reference numeral 301 denotes memory read access to a bank 1 which is accessed by the memory controller 105,

reference numeral 302 denotes a memory read request from the block 804 to the bank 1,

reference numeral 303 denotes a memory read request from the block 804 to the bank 2,

reference numeral 304 denotes memory read access from the block 804 to the bank 2,

reference numeral 305 denotes memory read access from the block 804 to the bank 1,

reference numeral 306 denotes 8-byte bank read data having been read from the bank 2 of the SDRAM 808, and

reference numeral 307 denotes 8-byte bank read data having been read from the bank 1 of the SDRAM 808.

The memory controller according to Embodiment 2 of the present invention is different from Embodiment 1 in that memory access is requested from the plurality of blocks 804, 805, and 806 for each piece of 8-byte bank access data in Embodiment 1, whereas memory access is requested in Embodiment 2 for each piece of 16-byte block access data which is constituted of two sets of 8-byte bank access data belonging to different banks. Hence, Embodiment 2 is different from Embodiment 1 in the following function: when a second-half bank where memory access is permitted by the arbitration circuit 101 immediately before is the same as the first-half bank of a subsequent memory access request, the order of the bank access data in the block access data is changed and access to the SDRAM 808 is controlled so that the access is made successively to the different banks of the SDRAM 808.

The following will describe the operations of the memory controller 105 when the block 804 reads data from the SDRAM 808 on the assumption that the mode setting of the SDRAM 808 is “CAS latency”=“3” and “burst length”=“2” and the memory access priority designating unit 1003 places higher priority on the blocks 804, 805, and 806 in this order to the SDRAM 808.

When the block 804 accesses the SDRAM 808, the block 804 passes a memory address, data, and a control signal via the memory controller 105. In response to the memory request (FIG. 3(B)) outputted from the block 804 to the arbitration circuit 101, the arbitration circuit 101 returns the memory access enabling signal (FIG. 3(C)) to the block 804 when no other block outputs a memory request to the SDRAM 808. When another block (blocks 805 and 806) outputs a memory request concurrently with the memory request of the block 804, the memory access enabling signal is returned to the block having higher priority according to the priority for making access to the SDRAM 808.

It is assumed that the memory controller 105 accesses the bank 1 of the SDRAM 808 (FIG. 3(D) 301), the memory read requests (FIG. 3(B) 302, 303) are outputted from the block 804 to the banks 1 and 2 of the SDRAM 808 in this order. When the memory read requests 302 and 303 are outputted from the block 804, the arbitration circuit 101 receives the memory requests and memory address in a request receiving block 1201. A bank decision unit 1202 decides that the memory access 301 and the memory read request 302 are memory read requests made to the same bank. The memory access 301 is made to the bank 1 to read second-half bank access data of 8 bytes which is accessed by the memory controller 105, and the memory read request 302 is made to read first-half bank access data of 8 bytes having been outputted from the block 804. The request receiving block 1201 instructs the enabling signal generation block 1005 to generate an enabling signal for the block 804. Further, the request receiving block 1201 changes the order of the memory access of the memory read request 302 for reading the first-half bank access data of 8 bytes and the memory read request 303 for reading the second-half bank access data of 8 bytes, and instructs the control signal generation block 1006 to generate a control signal for the memory read request 303 for reading the second-half bank access data of 8 bytes. The enabling signal generation block 1005 returns the memory access enabling signal (FIG. 3(B)) to the block 804 (access order change).

The control signal generation block 1006 is instructed by the request receiving block 1001 to generate a control signal and generates a command generation control signal, an address generation control signal, and a data latch control signal.

Based on the address generation control signal outputted from the arbitration circuit 101, the address generation block 103 receives a memory address from the block 804 permitted to access, changes the order of memory access, and outputs the memory address to the SDRAM 808. Based on the command generation control signal outputted from the arbitration circuit 101, the command generation block 102 performs the memory read access 305 to the bank after the memory read access 304 to the bank 2.

Based on the memory command outputted from the command generation block 102 and the memory address outputted from the address generation block 103, the SDRAM 808 reads the 8-byte bank access data 306 of D20 and D21 and the 8-byte bank access data 307 of D10 and D11.

In the data latch block 104, the read data latch block 1303 latches the bank access data 306 and 307 having been read from the SDRAM 808 in the access order (after access to the bank 2, access is made to the block 1) which has been changed in the arbitration circuit 101. Then, based on the data latch control signal outputted from the arbitration circuit 101, the data change block 1302 changes the order of the bank access data 306 and 307 having been read from the SDRAM 808 in the original access order (after access to the bank 1, access is made to the bank 2) for outputting the memory requests 302 and 303 from the block 804, and outputs the bank access data to the block 804 (change of the order of reading data).

With this configuration, when a second-half bank of the SDRAM 808 accessed by the memory controller 105 is the same as a bank serving as the target of access in the first half of a memory access request from a block making subsequent access, the arbitration circuit 101 changes the order of access in the first half and access in the second half, so that access is successively made to different banks. Thus, it is possible to eliminate a wait cycle disabling access to the SDRAM 808 and improve processing time.

Further, with the plurality of blocks for generating a memory address, it is possible to generate a memory address regardless of a bank accessed by the memory controller.

Moreover, even when the access order of the bank access data is changed for the SDRAM 808, 16-byte block access data is read from the SDRAM 808 and is stored in the data latch block 104, and the data latch block 104 transfers, in the reverse order of reading from the SDRAM 808, stored bank access data to a block having performed memory access. Thus, a block having made a memory access request can receive the block access data, which has been read by the SDRAM 808, regardless of a bank.

Embodiment 2 described as an example the case where the SDRAM 808 is set at “burst length”=“2”. The same effect can be obtained also by setting, e.g., “burst length”=“4”, “8”, and other values.

Moreover, Embodiment 2 described as an example the case where the SDRAM 808 is set at “CAS latency”=“3”. The same effect can be obtained also by setting, e.g., “CAS latency”=“2” and other values.

In Embodiment 2, the memory access priority designating unit 1003 may be set from the outside to change the priority of the blocks 804, 805, and 806 as in Embodiment 1. Also in this case, the same effect can be obtained.

Embodiment 2 described an example where memory is the SDRAM 808. The same effect can be obtained by other kinds of synchronous memory as well as SDRAM.

### Embodiment 3

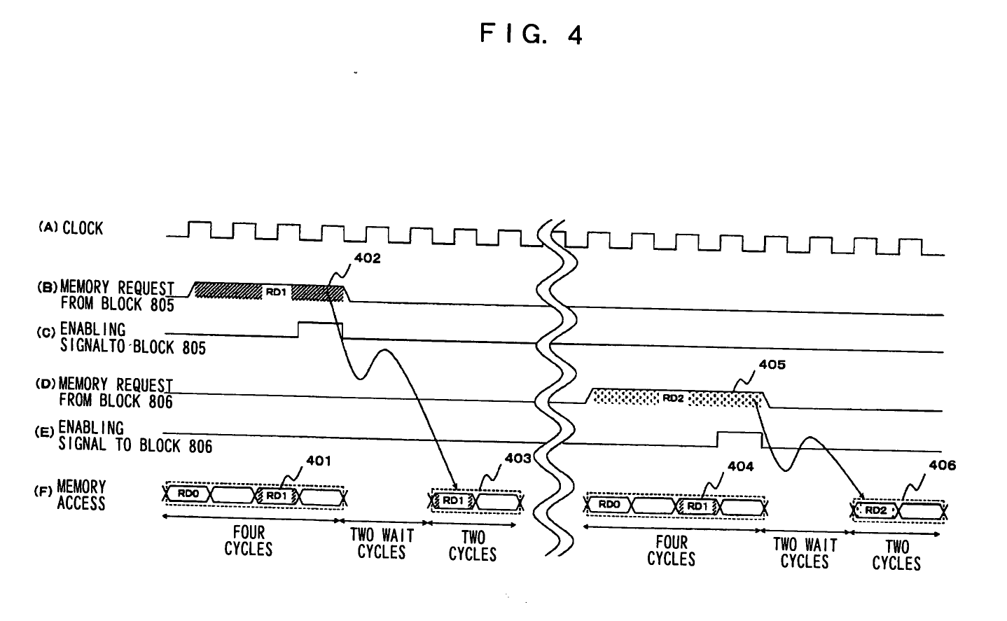

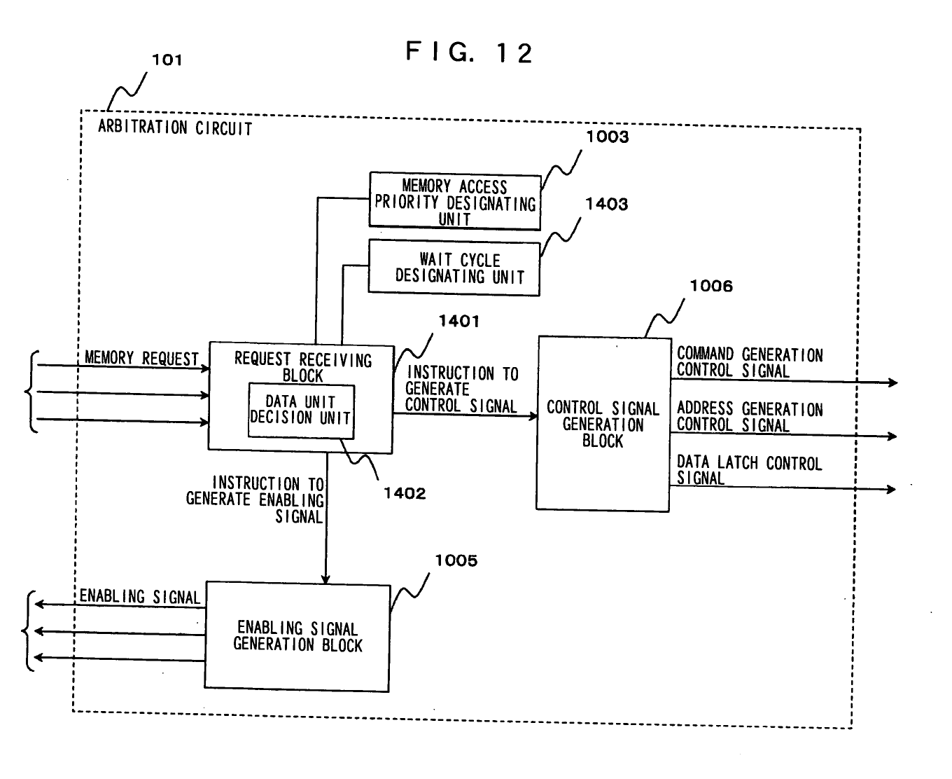

Referring to FIGS. 1, 4, and 12, the following will describe Embodiments 15 to 19 of the present invention. FIG. 4 is a timing chart showing the main signals of Embodiment 3. FIG. 12 is a block diagram showing an arbitration circuit of Embodiment 3.

A memory controller 105 is identical in configuration to Embodiment 1 (FIG. 1). Thus, the same figure numbers are used and the explanation of the configuration is omitted.

As shown in FIGS. 1 and 12, the arbitration circuit 101 is constituted of a request receiving block 1401 which receives memory requests from the plurality of blocks 804, 805, and 806, includes a data unit decision unit 1402 for deciding a data unit of requested memory access based on the received memory request, and provides an instruction to generate an enabling signal, a memory access priority designating unit 1003 for designating the priority of memory access from the plurality of blocks 804, 805, and 806, a wait cycle designating unit 1403 for designating the number of wait cycles when memory access requests from the plurality of blocks are made for each piece of bank access data, an enabling signal generation block 1005 which is instructed by the request receiving block 1401 to generate an enabling signal and outputs the enabling signal to a block permitted to access the memory, and a control signal generation block 1006 which is instructed to generate a control signal from the request receiving block and generates each control signal.

In FIG. 4,
(A) denotes a clock for operating the SDRAM 808,
(B) denotes a memory request outputted from the block 805 to the arbitration circuit 101,
(C) denotes a memory access enabling signal returned from the arbitration circuit 101 to the block 805,
(D) denotes a memory request outputted from the block 806 to the arbitration circuit 101,
(E) denotes a memory access enabling signal returned from the arbitration circuit 101 to the block 806, and
(F) denotes memory access performed on the SDRAM 808 by the memory controller 105.

Reference numeral 401 denotes memory access to a bank 1 which is accessed by the memory controller 105,

reference numeral 402 denotes a memory request from the block 804 to the bank 1,

reference numeral 403 denotes memory access from the block 805 to the bank 1,

reference numeral 404 denotes memory access to the bank 1 which is accessed by the memory controller 105,

reference numeral 405 denotes a memory request from the block 806 to the bank 2, and

reference numeral 406 denotes memory access from the block 806 to the bank 2.

The memory controller according to Embodiment 3 of the present invention is different from Embodiment 2 in that memory access is requested in Embodiment 2 from the plurality of blocks 804, 805, and 806 for each piece of 16-byte block access data which is constituted of two sets of 8-byte bank access data belonging to different banks, whereas Embodiment 3 has a block for making a memory access request for each piece of the 16-byte block access data and a block for making a memory access request for each piece of the 8-byte bank access data. Hence, Embodiment 3 is different from Embodiment 2 in the following function: of the plurality of blocks 804, 805, and 806, when the arbitration circuit 101 permits memory access requests from the blocks 805 and 806, the memory access requests being made by the bank access data alone, the request receiving block 1401 provides wait cycles as many as the number of cycles set by the wait cycle designating unit 1403, and control is performed so that the number of cycles of memory access for each piece of the bank access data is equal to the number of cycles of memory access for each piece of the block access data.

On the assumption that the mode setting of the SDRAM 808 is “CAS latency”=“3” and “burst length”=“2”, the memory access priority designating unit 1003 places higher priority on the blocks 804, 805, and 806 in this order to the SDRAM 808, and the wait cycle designating unit 1403 sets the number of wait cycles for one piece of byte access data, the following will describe the operations of the memory controller 105 in the case where the block 805, which requests a memory access by means of the byte access data alone, reads data from the same bank as memory access having been permitted by the arbitration circuit 101 immediately before. When the block 805 accesses the SDRAM 808, the block 805 passes a memory address, data, and a control signal via the memory controller 105. In response to the memory request (FIG. 4(B)) outputted from the block 805 to the arbitration circuit 101, the arbitration circuit 101 returns the memory access enabling signal (FIG. 4(C)) to the block 805 when no other block outputs a memory request to the SDRAM 808. When another block (e.g., the block 806) outputs the memory request (FIG. 4(D)) concurrently with the memory request of the block 805, the memory access enabling signal is returned to a block having higher priority according to the priority for making access to the SDRAM 808.

It is assumed that the memory controller 105 accesses (FIG. 4(F) 401) the bank 1 of the SDRAM 808 and a memory read request (FIG. 4(B) 402) is outputted from the block 805 to the bank 1 of the SDRAM 808. When the memory read request (FIG. 4(B) 402) is outputted from the block 805, the arbitration circuit 101 receives the memory request in the request receiving block 1401, and the data unit decision unit 1402 decides a data unit of a memory access request from the block 805. The arbitration circuit 101 instructs the enabling signal generation block 1005 to generate an enabling signal for the block 805, provides wait cycles as many as the number of cycles set by the wait cycle designating unit 1403 for one piece of the byte access data, and instructs the control signal generation block 1006 to generate a control signal for the memory access request of the block 805. The enabling signal generation block 1005 returns the memory access enabling signal (FIG. 4(C)) to the block 805 (access wait).

The control signal generation block 1006 is instructed by the request receiving block 1401 to generate a control signal and generates a command generation control signal, an address generation control signal, and a data latch control signal. The memory access 403 is performed on the SDRAM 808 according to the generated control signal.

Based on the address generation control signal outputted from the arbitration circuit 101, the address generation block 103 receives a memory address from the block 805 permitted to access, provides wait cycles of one piece of the bank access data, and outputs the wait cycles to the SDRAM 808. Based on the command generation control signal outputted from the arbitration circuit 101, the command generation block 102 provides wait cycles of one piece of the bank access data and performs the memory access 403.

The following will describe the operations of the memory controller 105 in the case where the block 806, which requests memory access by means of byte access data alone, reads data from a bank different from memory access having been permitted by the arbitration circuit 101 immediately before.

When the block 806 accesses the SDRAM 808, a memory address, data, and a control signal are passed via the memory controller 105 as in the case where the block 805 accesses the SDRAM 808. In response to the memory request (FIG. 4(D)) outputted from the block 806 to the arbitration circuit 101, the arbitration circuit 101 returns the memory access enabling signal (FIG. 4(E)) to the block 806 when no other block outputs a memory request to the SDRAM 808. When another block (e.g., the block 805) outputs the memory request (FIG. 4(B)) concurrently with the memory request of the block 806, the memory access enabling signal is returned to a block having higher priority according to the priority for making access to the SDRAM 808.

It is assumed that the memory controller 105 accesses (FIG. 4(F) 404) the bank 1 of the SDRAM 808, the memory read request (FIG. 4(D) 405) is outputted from the block 806 to the bank 2 of the SDRAM 808. When the memory read request (FIG. 4(D) 405) is outputted from the block 806, the arbitration circuit 101 receives the memory request in the request receiving block 1401, and the data unit decision unit 1402 decides a data unit of a memory access request from the block 806. The arbitration circuit 101 instructs the enabling signal generation block 1005 to generate an enabling signal for the block 806, provides the number of wait cycles set by the wait cycle designating unit 1403 for one piece of the byte access data, and instructs the control signal generation block 1006 to generate a control signal for the memory access request of the block 806. The enabling signal generation block 1005 returns the memory access enabling signal (FIG. 4(E)) to the block 806 (access wait).

The control signal generation block 1006 is instructed by the request receiving block 1401 to generate a control signal and generates a command generation control signal, an address generation control signal, and a data latch control signal. The memory read access 406 is performed on the SDRAM 808 according to the generated control signal.

Based on the address generation control signal outputted from the arbitration circuit 101, the address generation block 103 receives a memory address from the block 806 permitted to access, provides wait cycles of one piece of the bank access data, and outputs the wait cycles to the SDRAM 808. Based on the command generation control signal outputted from the arbitration circuit 101, the command generation block 102 provides wait cycles of one piece of the bank access data and performs the memory access 406.

With this configuration, when the arbitration circuit 101 permits a memory access request of 8-byte bank access data alone, the number of wait cycles set by the wait cycle designating unit 1403 is provided for one piece of byte access data, and the control signal generating block 1006 is instructed to generate a control signal for the memory access request of the block 806. Thus, it is possible to achieve memory access without being affected by the bank of immediately preceding memory access and reduce necessary circuits because memory access is performed by the bank access data alone.

Embodiment 3 described as an example the case where the SDRAM 808 is set at “burst length”=“2”. The same effect can be obtained also by setting, e.g., “burst length”=“4”, “8”, and other values.

Embodiment 3 described as an example the case where the SDRAM 808 is set at “CAS latency”=“3”. The same effect can be obtained also by setting, e.g., “CAS latency”=“2” and other values.

In Embodiment 3, the memory access priority designating unit 1003 may be set from the outside to change the priority of the blocks 804, 805, and 806 as in Embodiment 1. Also in this case, the same effect can be obtained.

Further, Embodiment 3 described an example where wait cycles for one piece of bank access data are provided. The wait cycle designating unit 1403 may be set outside to change the number of wait cycles. Also in this case, the same effect can be obtained.

Embodiment 3 described an example where memory is the SDRAM 808. The same effect can be obtained by other kinds of synchronous memory as well as SDRAM.

### Embodiment 4

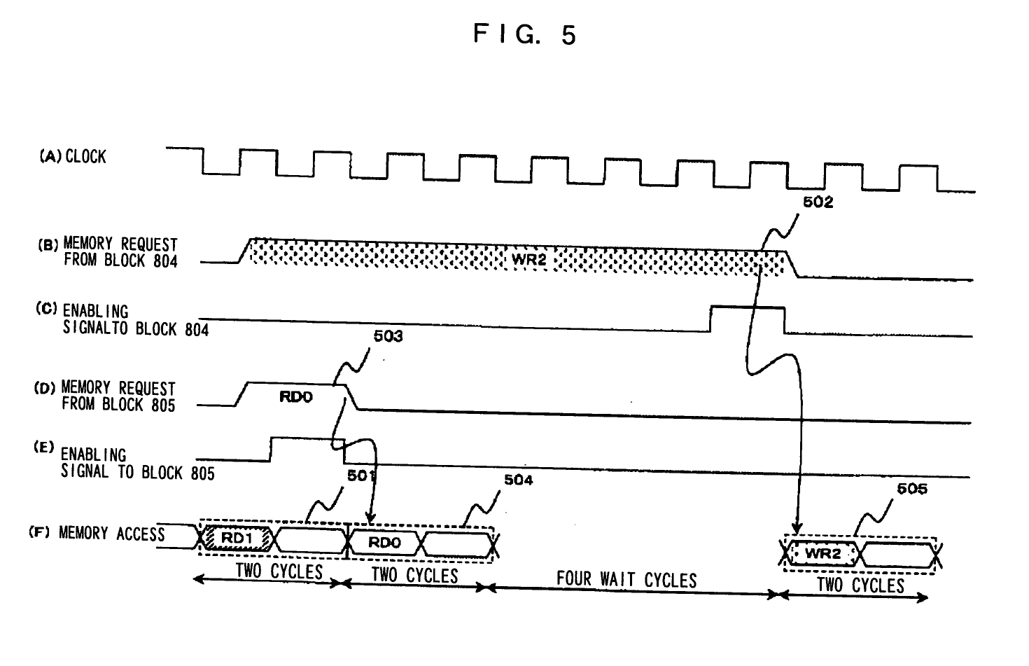

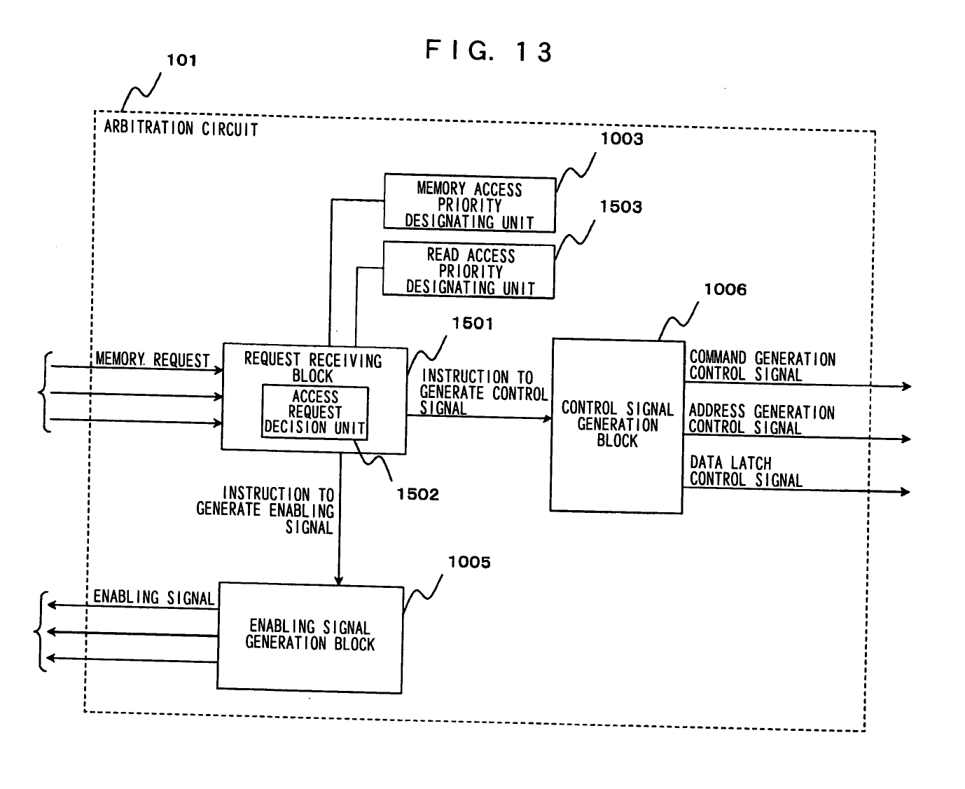

Referring to FIGS. 1, 5, 13, and 14, the following will describe Embodiments 20 to 26 of the present invention. FIG. 5 is a timing chart showing the main signals of Embodiment 4. FIG. 13 is a block diagram showing an arbitration circuit of Embodiment 4.

A memory controller 105 is identical in configuration to Embodiment 1 (FIG. 1). Thus, the same figure numbers are used and the explanation of the configuration is omitted.

As shown in FIGS. 1 and 13, the arbitration circuit 101 is constituted of a request receiving block 1501 which receives memory requests from a plurality of blocks 804, 805, and 806, includes an access request decision unit 1502 for deciding the kind of requested memory access based on the received memory request, and provides an instruction to generate an enabling signal, a memory access priority designating unit 1003 for designating the priority of memory access from the plurality of blocks, a read access priority designating unit 1503 for selecting a block to be subsequently permitted to perform read access when memory access permitted immediately before is read access, an enabling signal generation block 1005 which is instructed by the request receiving block to generate an enabling signal and outputs the enabling signal to a block permitted to access the memory, and a control signal generation block 1006 which is instructed by the request receiving block to generate a control signal and generates each control signal.

In FIG. 5,
(A) denotes a clock for operating SDRAM 808,
(B) denotes a memory request outputted from the block 804 to the arbitration circuit 101,
(C) denotes a memory access enabling signal returned from the arbitration circuit 101 to the block 804,
(D) denotes a memory request outputted from the block 805 to the arbitration circuit 101,
(E) denotes a memory access enabling signal returned from the arbitration circuit 101 to the block 805, and
(F) denotes memory access performed on the SDRAM 808 by the memory controller 105.

Reference numeral 501 denotes memory read access to a bank 1 which is accessed by the memory controller 105,

reference numeral 502 denotes a memory write request from the block 804 to a bank 2,

reference numeral 503 denotes a memory read request from the block 805 to a bank 0,

reference numeral 504 denotes memory read access from the block 805 to the bank 0, and

reference numeral 505 denotes memory write access from 10 the block 804 to the bank 2.

The memory controller according to Embodiment 4 of the present invention is different from Embodiment 1 in that the arbitration circuit 101 of Embodiment 1 changes the priority of memory access from the plurality of blocks 804, 805, and 806 so as to make access to a different bank from memory access having been permitted by the arbitration circuit 101 immediately before, whereas Embodiment 4 changes the priority of memory access from the plurality of blocks when memory access permitted by the arbitration circuit 101 immediately before is read access.

First, the following will describe the case where memory access permitted by the arbitration circuit 101 immediately before is read access and a subsequent memory access request is made for read access.

On the assumption that the mode setting of the SDRAM 808 is “CAS latency”=“3” and “burst length”=“2”, the memory access priority designating unit 1003 places higher priority on the blocks 804, 805, and 806 in this order to the SDRAM 808, the following will describe the operations of the memory controller 105 when the block 804 writes data in the SDRAM 808.

When the block 804 accesses the SDRAM 808, the block 804 passes a memory address, data, and a control signal via the memory controller 105. In response to the memory request (FIG. 5(B)) outputted from the block 804 to the arbitration circuit 101, the arbitration circuit 101 returns the memory access enabling signal (FIG. 5(C)) to the block 804 when no other block outputs a memory request to the SDRAM 808. When another block (the blocks 805 and 806) outputs the memory request (FIG. 5(D)) concurrently with the memory request of the block 804, the memory access enabling signal is returned to a block having higher priority according to the priority for making access to the SDRAM 808.

It is assumed that the memory controller 105 performs read access (FIG. 5(F) 501) on the bank 1 of the SDRAM 808, the memory write request (FIG. 5(B) 502) is outputted from the block 804 to the bank 2 of the SDRAM 808, and the memory read request (FIG. 5(D) 503) is simultaneously outputted from the block 805 to the bank 0 of the SDRAM 808. The arbitration circuit 101 receives in the request receiving block 1501 the memory request outputted from the blocks 804 and 805, and the access request decision unit 1502 decides that the block 805 outputs the same read access request (FIG. 5(D) 503) as read access (FIG. 5(F) 501) permitted immediately before. The arbitration circuit 101 instructs the enabling signal generation block 1005 to generate an enabling signal to the block 805, and the arbitration circuit 101 places higher priority on the memory read request 503, which is outputted from the block 805 to the bank 0 of the SDRAM 808, than the memory write request outputted from the block 804 to the bank 2. Further, the arbitration circuit 101 instructs the control signal generation block 1006 to generate a control signal for the memory access request of the block 805. The enabling signal generation block 1005 returns the memory access enabling signal (FIG. 5(E)) to the block 805 (assignment of higher priority on read access).

The control signal generation block 1006 is instructed by the request receiving block 1501 to generate a control signal and generates a command generation control signal, an address generation control signal, and a data latch control signal. The memory read access 504 is performed on the SDRAM 808 according to the generated control signal.

Thereafter, a wait cycle is provided during which data is read from the SDRAM 808, the memory write request 502 to the bank 2 of the SDRAM 808 is received from the block 804, the memory access enabling signal (FIG. 5(C)) is returned to the block 804, and the memory write access 505 from the block 804 to the bank 2 is performed.

The operations of the command generation block 102, the address generation block 103, and the data latch block 104 are similar to those of Embodiment 1 and thus the explanation thereof is omitted.

The following will describe the case where the priority of read access is increased when memory access permitted by the arbitration circuit 101 immediately before is read access.

On the assumption that the mode setting of the SDRAM 808 is “CAS latency”=“3” and “burst length”=“2”, the memory access priority designating unit 1003 places higher priority on the blocks 804, 805, and 806 in this order to the SDRAM 808, the block 804 outputs a memory write request to the bank 2, and the block 805 outputs a memory read request to the bank 0.

When access permitted by the arbitration circuit 101 immediately before is read access and the memory controller 105 performs memory read access (FIG. 5(F) 501) on the bank 1, the access request decision unit 1502 lowers the priority of write access when the immediately preceding read access is permitted. When the memory write request (FIG. 5(B) 502) to the bank 2 of the SDRAM 808 is outputted from the block 804 and the memory read request (FIG. 5(D) 503) to the bank 0 is simultaneously outputted from the block 805, the request receiving block 1501 instructs the enabling signal generation block 1005 to generate an enabling signal for the block 805 and instructs the control signal generation block 1006 to generate a control signal for the memory access request of the block 805. The enabling signal generation block 1005 returns the memory access enabling signal (FIG. 5(E)) to the block 805 (assignment of higher priority on read access).

The control signal generation block 1006 is instructed by the request receiving block 1501 to generate a control signal and generates a command generation control signal, an address generation control signal, and a data latch control signal. The memory read access 504 is performed on the SDRAM 808 according to the generated control signal. Thereafter, await cycle is provided during which data is read from the SDRAM 808, the memory write request 502 from the block 804 to the bank 2 of the SDRAM 808 is received, the memory access enabling signal (FIG. 5(C)) is returned to the block 805, and the memory write access 505 from the block 804 to the bank 2 is performed.

The operations of the command generation block 102, the address generation block 103, and the data latch block 104 are similar to those of Embodiment 1 and thus the explanation thereof is omitted.

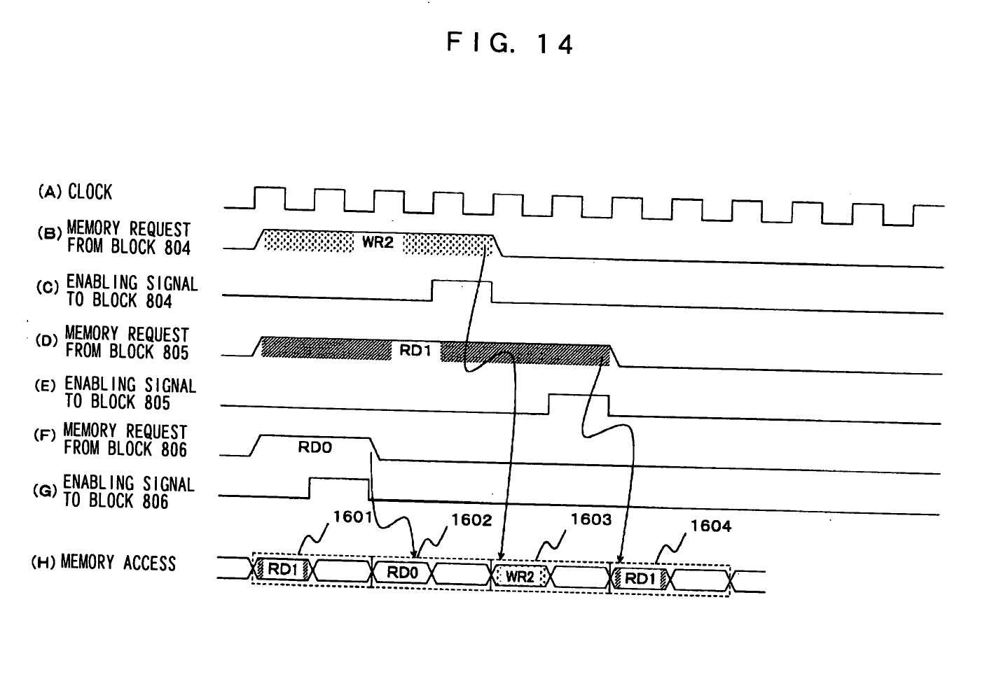

Referring FIG. 14, the following will describe the case where a block to be subsequently permitted to perform read access is selected when memory access permitted by the arbitration circuit 101 immediately before is read access. FIG. 14 is a timing chart showing that read access is subsequently permitted when memory access permitted by the arbitration circuit 101 immediately before is read access in Embodiment 4.

In FIG. 14,
(A) denotes a clock for operating the SDRAM 808,
(B) denotes a memory request outputted from the block 804 to the arbitration circuit 101,
(C) denotes a memory access enabling signal returned from the arbitration circuit 101 to the block 804,
(D) denotes a memory request outputted from the block 805 to the arbitration circuit 101,
(E) denotes a memory access enabling signal returned from the arbitration circuit 101 to the block 805,
(F) denotes a memory request outputted from the block 806 to the arbitration circuit 101,
(G) denotes a memory access enabling signal returned from the arbitration circuit 101 to the block 806, and
(H) denotes memory access performed on the SDRAM 808 by the memory controller 105.

Reference numeral 1601 denotes memory read access to the bank 1 which is accessed by the memory controller 105,

reference numeral 1602 denotes memory read access from the block 806 to the bank 0,

reference numeral 1603 denotes memory write access from the block 804 to the bank 2, and

reference numeral 1604 denotes memory read access from the block 805 to the bank 1.

Hereinafter, it is assumed that the mode setting of the SDRAM 808 is “CAS latency”=“3” and “burst length”=“2”, higher priority to the SDRAM 808 is given to the blocks 804, 805, and 806 in this order in the memory access priority designating unit 1003. When memory access permitted immediately before is read access, higher priority is given to the blocks 806, 805, and 804 in this order in the read access priority designating unit 1503 regarding a block to be subsequently permitted to perform read access, the block 804 outputs a memory write request to the bank 2, the block 805 outputs a memory read request to the bank 1, and the block 806 outputs a memory read request to the bank 0.

In the case where access permitted by the arbitration circuit 101 immediately before is memory read access to the bank 1 and the memory controller 105 performs memory read access on the bank 1 (FIG. 14(H) 1601), when the memory write request (FIG. 14(B)) to the bank 2 of the SDRAM 808 is outputted from the block 804, the arbitration circuit 101 receives, in the request receiving block 1501, memory requests outputted from the blocks 804, 805, and 806, decides, in the access request decision unit 1502, that the same read access request as the read access permitted immediately before (FIG. 14(H) 1601) is outputted from the blocks 805 and 806 (FIGS. 14(D) and 14(F)), and the arbitration circuit 101 instructs the enabling signal generation block 1005 to generate an enabling signal for the block 806 according to the setting of the read access priority designating unit 1503. Further, the arbitration circuit 101 instructs the control signal generation block 1006 to generate a control signal for the memory access request of the block 806. The enabling signal generation block 1005 returns the memory access enabling signal (FIG. 14(G)) to the block 806 (priority change for read access).

Based on the address generation control signal outputted from the arbitration circuit 101, the address generation block 103 receives a memory address from the block 806 permitted to access and outputs the memory address to the SDRAM 808. Based on the command generation control signal outputted from the arbitration circuit 101, the command generation block 102 generates a memory command such as RAS and CAS, outputs the memory command to the SDRAM 808, and performs the memory read access 1602 from the block 806 to the bank 0.

When the memory read access 1602 from the block 806 to the bank 0 is completed, the memory write access 1603 from the block 804 to the bank 2 is performed according to the priority for permitting memory access, and then, the memory read access 1604 from the block 805 to the bank 1 is performed.

With this configuration, when the memory controller 105 performs memory read access on the SDRAM 808, the arbitration circuit 101 increases the priority of read access and changes the priority of memory access requests so as to successively perform read access, thereby eliminating a wait cycle disabling access to the SDRAM 808 and improving processing time.

Embodiment 4 described as an example the case where the SDRAM 808 is set at “burst length”=“2”. The same effect can be obtained also by setting, e.g., “burst length”=“4”, 8”, and other values.

Embodiment 4 described as an example the case where the SDRAM 808 is set at “CAS latency”=“3”. The same effect can be obtained also by setting, e.g., “CAS latency”=“2” and other values.

In Embodiment 4, the memory access priority designating unit 1003 may be set from the outside to change the priority of the blocks 804, 805, and 806 as in Embodiment 1. Also in this case, the same effect can be obtained.

Further, Embodiment 4 described an example where higher priority is given to the blocks 806, 805, and 804 in this order regarding a block to be subsequently permitted to perform read access when memory access permitted immediately before is read access. The read access priority order designating unit 1503 may be set from the outside to change the priority of the blocks 804, 805, and 806. Also in this case, the same effect can be obtained.

Embodiment 4 described an example where memory is the SDRAM 808. The same effect can be obtained by other kinds of synchronous memory as well as SDRAM.

### Embodiment 5

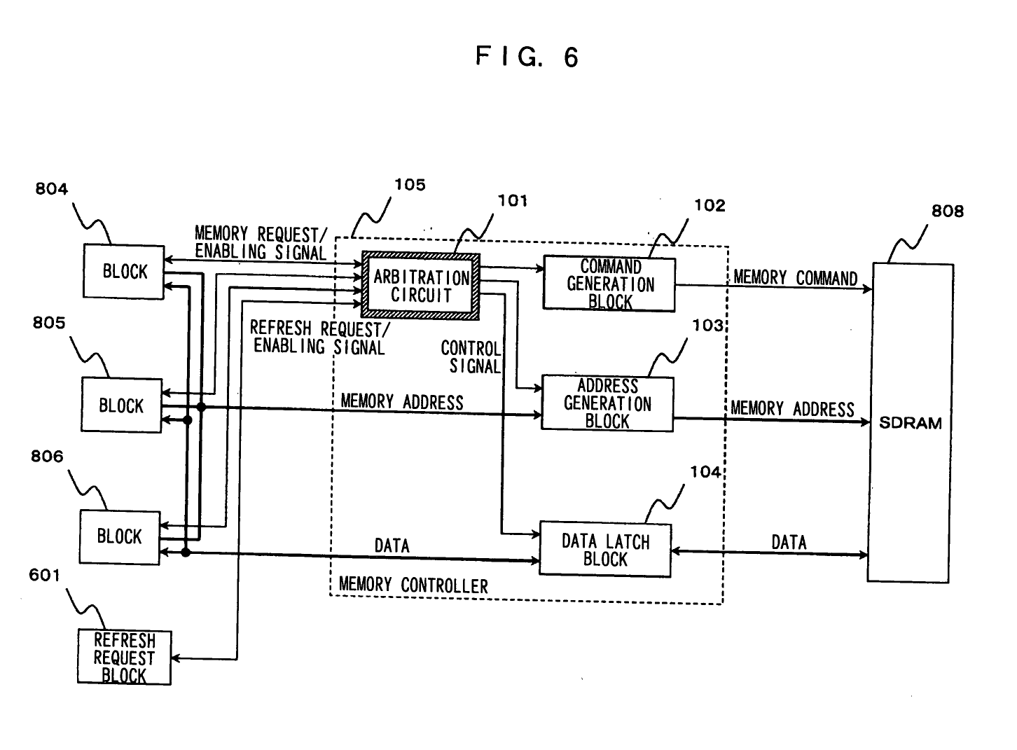

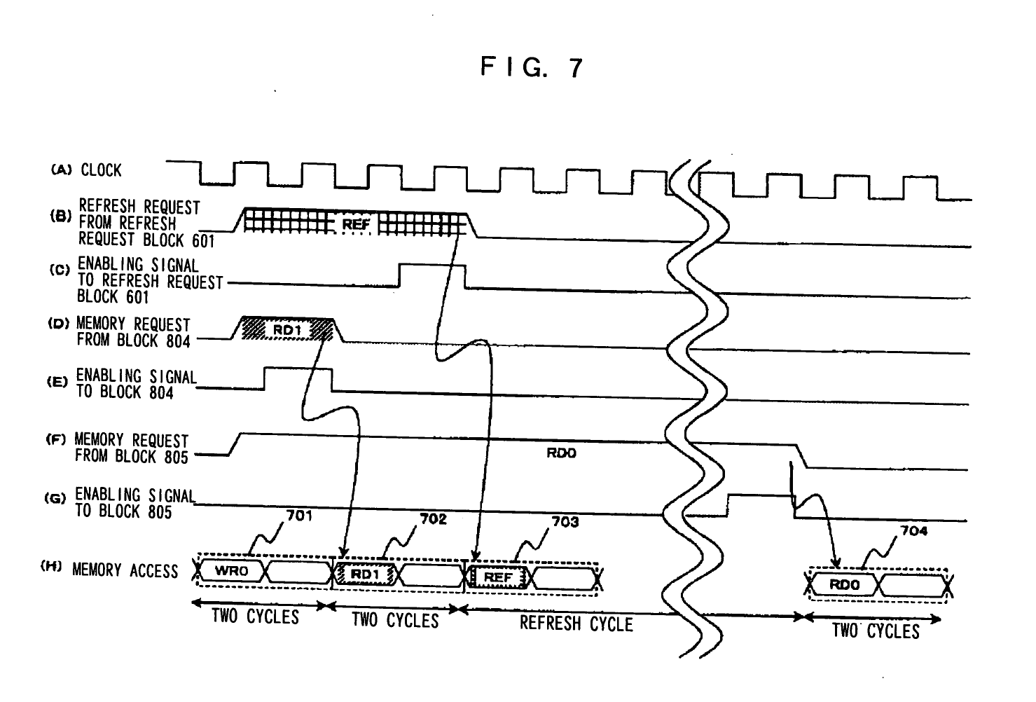

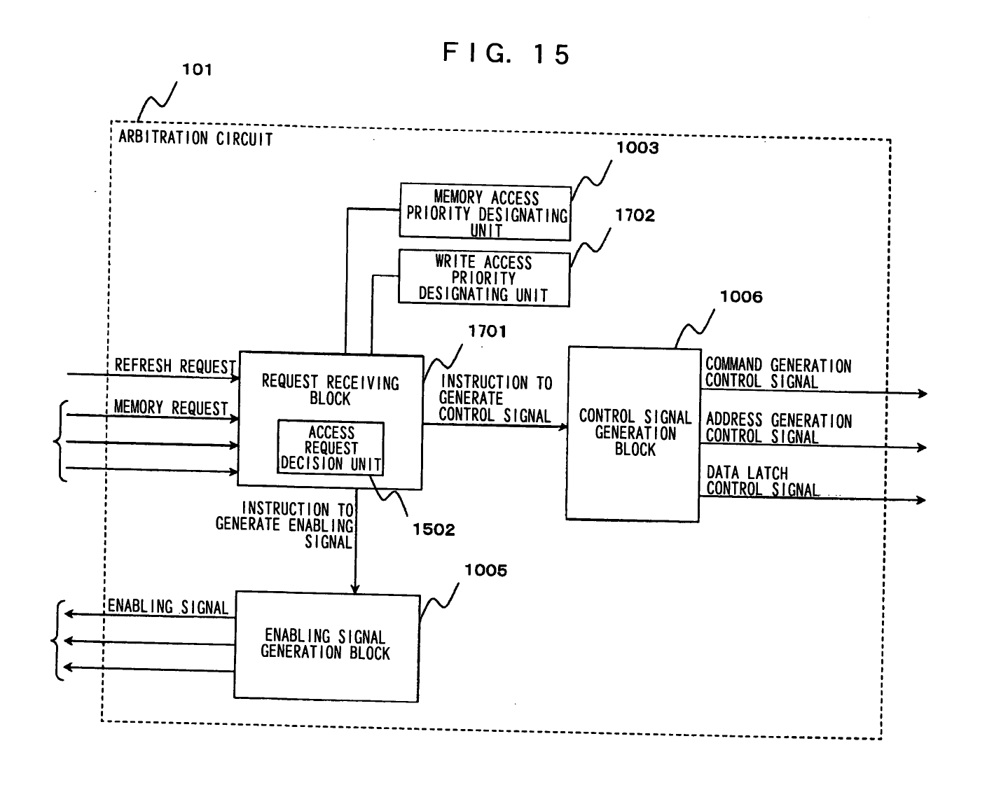

Referring to FIGS. 6, 7, 15, and 16, the following will describe Embodiments 27 to 33 of the present invention. FIG. 6 is a block diagram showing a memory controller of the present invention. FIG. 7 is a timing chart showing the main signals of Embodiment 5. FIG. 15 is a block diagram showing an arbitration circuit of Embodiment 5.

In FIG. 6, an arbitration circuit 101, a command generation block 102, an address generation block 103, and a data latch block 104 in a memory controller 105 are identical in configuration to those of Embodiment 1. Thus, the explanation of the configurations is omitted. Embodiment 5 has a refresh request block 601 which outputs a refresh request signal to the arbitration circuit 101 every set period of time in order to store the internal data of SDRAM 808.

As shown in FIG. 15, the arbitration circuit 101 is constituted of a request receiving block 1701 which receives are fresh request from the refresh request block 601 and memory requests from a plurality of blocks 804, 805, and 806, includes an access request decision unit 1502 for deciding the kind of requested memory access based on the received refresh request and memory request, and provides an instruction to generate an enabling signal, a memory access priority designating unit 1003 for designating the priority of memory access from the plurality of blocks, a write access priority designating unit 1702 for selecting a block to be subsequently permitted to access the memory when a refresh request is outputted from the refresh request block and memory access permitted by the arbitration circuit immediately before is write access, an enabling signal generation block 1005 which is instructed by the request receiving block 1701 to generate an enabling signal and outputs the enabling signal to a block permitted to access the SDRAM 808, and a control signal generation block 1006 which is instructed by the request receiving block 1701 to generate a control signal and generates a command generation control signal, an address generation control signal, and a data latch control signal.

In FIG. 7,
(A) denotes a clock for operating the SDRAM 808,
(B) denotes a refresh request signal outputted from the refresh request block 601,
(C) denotes a refresh enabling signal from the arbitration circuit 101 to the refresh request block 601,
(D) denotes a memory request outputted from the block 804 to the arbitration circuit 101,
(E) denotes a memory access enabling signal returned from the arbitration circuit 101 to the block 804,
(F) denotes a memory request outputted from the block 805 to the arbitration circuit 101,
(G) denotes a memory access enabling signal returned from the arbitration circuit 101 to the block 805, and
(H) denotes memory access performed on the SDRAM 808 by the memory controller 105.

Reference numeral 701 denotes memory write access to a bank 1 which is accessed by the memory controller 105,

reference numeral 702 denotes memory read access from the block 804 to the bank 1,

reference numeral 703 denotes the refresh of the refresh request block 601, and

reference numeral 704 denotes memory read access from the block 805 to a bank 0.

The memory controller according to Embodiment 5 of the present invention is different from Embodiment 4 in that the arbitration circuit 101 of Embodiment 4 changes the priority of memory access from the plurality of blocks when memory access permitted immediately before by the arbitration circuit 101 is read access, whereas Embodiment 5 changes the priority of memory access from the plurality of blocks when memory access permitted immediately before is write access.

First, the following will describe the case where memory access permitted by the arbitration circuit 101 immediately before is write access and a refresh request is outputted from a refresh request block.

On the assumption that the mode setting of the SDRAM 808 is “CAS latency”=“3” and “burst length”=“2” and the memory access priority designating unit 1003 places higher priority on the refresh request block 601 and the blocks 804, 805, and 806 in this order to the SDRAM 808, the following will describe the operations of the memory controller 105 when the refresh request block 601 performs refresh on the SDRAM 808.

When the refresh request block 601 accesses the SDRAM 808, the refresh request block 601 passes a control signal via the memory controller 105. In response to the refresh request signal (FIG. 7(B)) outputted from the refresh request block 601 to the arbitration circuit 101, the arbitration circuit 101 returns the refresh enabling signal (FIG. 7(C)) to the refresh request block 601 when no other block outputs a memory request to the SDRAM 808. When another block (the blocks 804, 805, and 806) outputs the memory request (FIGS. 7(D) and 7(F)) concurrently with the refresh request signal of the refresh request block 601, the enabling signal is returned to a block having higher priority according to the priority for making access to the SDRAM 808.

It is assumed that the memory controller 105 performs write access on the bank 0 of the SDRAM 808 (FIG. 7(H) 701), the refresh request signal (FIG. 7(B)) is outputted from the refresh request blocks 601, the memory read request (FIG. 7(D)) is simultaneously outputted from the block 804 to the bank 1, and the memory read request (FIG. 7(F)) is outputted from the block 805 to the bank 0. The arbitration circuit 101 receives, in the request receiving block 1701, the refresh request outputted from the refresh request block 601 and the memory requests outputted from the blocks 804 and 805. The access request decision unit 1502 decides that the refresh request (FIG. 7(B)) is outputted. The arbitration circuit 101 instructs the enabling signal generation block 1005 to generate an enabling signal for the block 804, lowers the priority of the refresh request outputted from the refresh request block, and instructs the control signal generation block 1006 to generate a control signal for the memory access request of the block 804. The enabling signal generation block 1005 returns the memory access enabling signal (FIG. 7(E)) to the block 804 (refresh order change).

The control signal generation block 1006 is instructed by the request receiving block 1701 to generate a control signal and generates a command generation control signal, an address generation control signal, and a data latch control signal. The memory read access 702 is performed on the SDRAM 808 according to the generated control signal.

Thereafter, the refresh 703 is performed on the SDRAM 808. When the refresh is completed, the memory read request (FIG. 7(F)) outputted from the block 805 to the bank 0 of the SDRAM 808 is received, the memory access enabling signal (FIG. 7(G)) is returned to the block 805, and the memory read access 704 from the block 805 to the bank 0 is performed.

The operations of the command generation block 102, the address generation block 103, and the data latch block 104 are similar to those of Embodiment 1 and thus the explanation thereof is omitted.

The following will describe the case where the priority of a refresh request is lowered when memory access permitted by the arbitration circuit 101 immediately before is write access.

Hereinafter, it is assumed that the mode setting of the SDRAM 808 is “CAS latency”=“3” and “burst length”=“2”, higher priority to the SDRAM 808 is given to the blocks 804, 805, and 806 in this order in the memory access priority designating unit 1003, a refresh request signal is outputted from the refresh request block 601, a memory read request is outputted from the block 804 to the bank 1, and a memory read request is outputted from the block 805 to the bank 0.

When access permitted by the arbitration circuit 101 immediately before is write access and the memory controller 105 performs memory write access on the bank 0 (FIG. 7(H) 701), the access request decision unit 1502 lowers the priority of a refresh request when the immediately preceding write access is permitted. When the memory write request (FIG. 7(D)) is outputted from the block 804 to the bank 1 of the SDRAM 808 and the memory read request (FIG. 7(F)) is simultaneously outputted from the block 805 to the bank 0, the request receiving block 1701 instructs the enabling signal generation block 1005 to generate an enabling signal for the block 804. Further, the request receiving block 1701 instructs the control signal generation block 1006 to generate a control signal for the memory access request of the block 804. The enabling signal generation block 1005 returns the memory access enabling signal (FIG. 7(E)) to the block 804 (refresh order change).

The control signal generation block 1006 is instructed by the request receiving block 1701 to generate a control signal and generates the command generation control signal, the address generation control signal, and the data latch control signal. The memory read access 702 is performed on the SDRAM 808 according to the generated control signal.

Thereafter, the refresh 703 is performed on the SDRAM 808. When the refresh is completed, the memory read request (FIG. 7(F)) to the bank 0 of the SDRAM 808 is received, the memory access enabling signal (FIG. 7(G)) is returned to the block 805, and the memory read access 704 from the block 805 to the bank 0 is performed.

The operations of the command generation block 102, the address generation block 103, and the data latch block 104 are similar to those of Embodiment 1 and thus the explanation thereof is omitted.

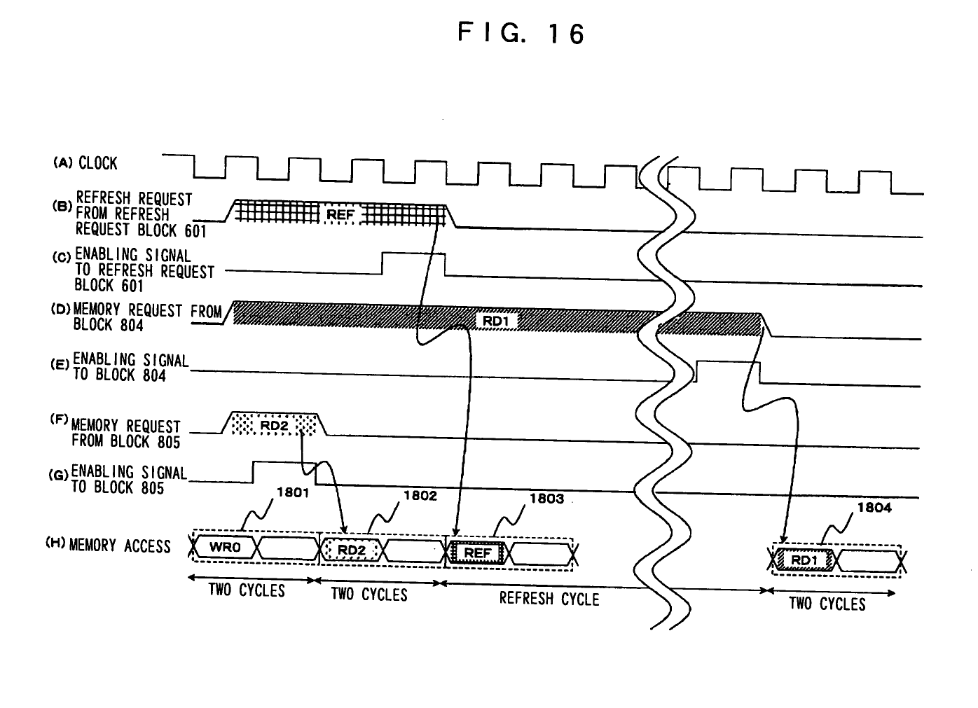

Referring to FIG. 16, the following will describe that when memory access permitted by the arbitration circuit 101 immediately before is write access, a block to be subsequently permitted to perform read access is selected. FIG. 16 is a timing chart showing that read access is subsequently permitted when memory access permitted immediately before is write access in Embodiment 5.

In FIG. 16,
(A) denotes a clock for operating the SDRAM 808,
(B) denotes a refresh request signal outputted from the refresh request block 601,
(C) denotes a refresh enabling signal from the arbitration circuit 101 to the refresh request block 601,
(D) denotes a memory request outputted from the block 804 to the arbitration circuit 101,
(E) denotes a memory access enabling signal returned from the arbitration circuit 101 to the block 804,
(F) denotes a memory request outputted from the block 805 to the arbitration circuit 101,
(G) denotes a memory access enabling signal returned from the arbitration circuit 101 to the block 805, and
(H) denotes memory access performed on the SDRAM 808 by the memory controller 105.

Reference numeral 1801 denotes memory write access to the bank 0 which is accessed by the memory controller 105,

reference numeral 1802 denotes memory read access from the block 805 to the bank 2,

reference numeral 1803 denotes the refresh of the refresh request block 601, and

reference numeral 1804 denotes memory read access from the block 804 to the bank 1.

Hereinafter, it is assumed that the mode setting of the SDRAM 808 is “CAS latency”=“3” and “burst length”=“2”, higher priority to the SDRAM 808 is given to the refresh request block 601 and the blocks 804, 805, and 806 in this order in the memory access priority designating unit 1003, when memory access permitted immediately before is write access, higher priority is given to the blocks 806, 805, and 804 and the refresh request block 601 in this order in the write access priority designating unit 1702 regarding a block to be subsequently permitted to perform read access. Further, it is assumed that the refresh request block 601 outputs a refresh request, the block 804 outputs a memory read request to the bank 1, and the block 805 outputs a memory read request to the bank 2.

In the case where access permitted by the arbitration circuit 101 immediately before is memory write access to the bank 0 and the memory controller 105 performs memory write access on the bank 0 (FIG. 16(H) 1801), the arbitration circuit 101 receives, in the request receiving block 1701, a refresh request signal outputted from the refresh request block 601 and memory requests outputted from the blocks 804, 805, and 806, decides, in the access request decision unit 1502, that the refresh request (FIG. 16(B)) is outputted and read requests are outputted from the blocks 804 and 805 (FIGS. 16(D) and 16(F)), and instructs the enabling signal generation block 1005 to generate an enabling signal for the block 805 according to the setting of the write access priority designating unit 1702. Further, the arbitration circuit 101 instructs the control signal generation block 1006 to generate a control signal for a memory access request of the block 805. The enabling signal generation block 1005 returns the memory access enabling signal (FIG. 16(G)) to the block 805 (write access priority change).

Based on the address generation control signal outputted from the arbitration circuit 101, the address generation block 103 receives a memory address from the block 805 permitted to access and outputs the memory address to the SDRAM 808. Based on the command generation control signal outputted from the arbitration circuit 101, the command generation block 102 generates a memory command such as RAS and CAS, outputs the memory command to the SDRAM 808, and performs the memory read access 1802 from the block 805 to the bank 2.

When the memory read access 1802 from the block 805 to the bank 2 is completed, there fresh 1803 of the refresh request block 601 is performed according to the priority for permitting memory access, and then, the memory read access 1604 from the block 804 to the bank 1 is performed.

With this configuration, when the memory controller 105 performs memory write access on the SDRAM 808, the arbitration circuit 101 lowers the priority of refresh performed after the write access and receives a read access request from another block, thereby eliminating a wait cycle disabling access to the SDRAM 808 and improving processing time.

Embodiment 5 described as an example the case where the SDRAM 808 is set at “burst length”=“2”. The same effect can be obtained also by setting, e.g., “burst length”=“4”, “8”, and other values.

Embodiment 5 described as an example the case where the SDRAM 808 is set at “CAS latency”=“3”. The same effect can be obtained also by setting, e.g., “CAS latency”=“2” and other values.

In Embodiment 5, the memory access priority designating unit 1003 may be set from the outside to change the priority of the blocks 804, 805, and 806 as in Embodiment 1. Also in this case, the same effect can be obtained.

Further, Embodiment 5 described an example where higher priority is given to the blocks 806, 805, and 804 in this order regarding a block to be subsequently permitted to perform read access when memory access permitted immediately before is write access. The write access priority order designating unit 1702 may be set from the outside to change the priority of the blocks 804, 805, and 806. Also in this case, the same effect can be obtained.

Embodiment 5 described an example where memory is the SDRAM 808. The same effect can be obtained by other kinds of synchronous memory as well as SDRAM.

### Embodiment 6

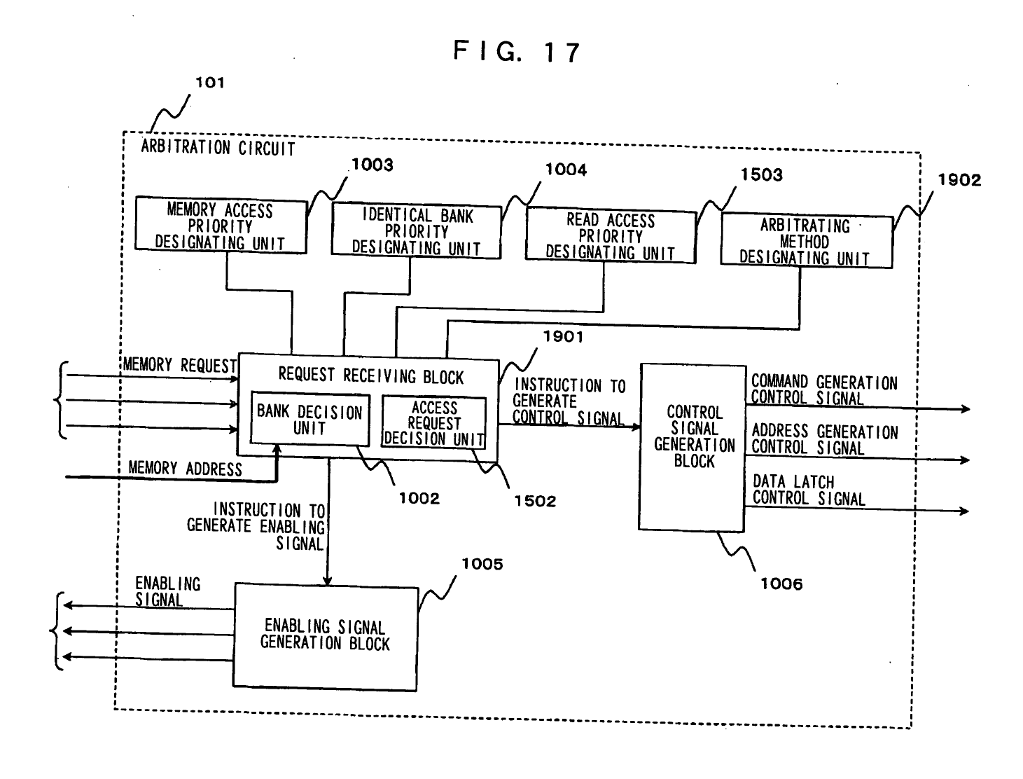

Referring to FIGS. 1 and 17, the following will describe Embodiments 34 to 40 of the present invention. FIG. 17 is a block diagram showing an arbitration circuit of Embodiment 6.

A memory controller 105 is identical in configuration to that of Embodiment 1 (FIG. 1). Thus, the same figure numbers are used and the explanation of the configuration is omitted.

As shown in FIGS. 1 and 17, in the arbitration circuit 101, a request receiving block 1901 includes the bank decision unit 1002 and the access request decision unit 1502 described in Embodiments 1 and 4. The arbitration circuit 101 receives memory requests and a memory address from the plurality of blocks 804, 805, and 806 and the request receiving block 1901 provides an instruction to generate an enabling signal. The arbitration circuit 101 is constituted of a memory access priority designating unit 1003 for designating the priority of memory access from the plurality of blocks 804, 805, and 806, an arbitrating method designating unit 1902 for designating an arbitrating method for changing the priority of memory access when memory access requests from the plurality of blocks 804, 805, and 806 are made to the same bank as immediately preceding access and memory access permitted by the arbitration circuit 101 immediately before is read access, an identical bank priority designating unit 1004 for selecting a block to be subsequently permitted to access when the arbitrating method designating unit 1902 is set so as to place higher priority on a bank, a read access priority designating unit 1503 for selecting a block to be subsequently permitted to perform read access when the arbitrating method designating unit 1902 is set so as to place higher priority on access, an enabling signal generation block 1005 which is instructed by the request receiving block 1901 to generate an enabling signal and outputs the enabling signal to a block permitted to access the SDRAM 808, and a control signal generation block 1006 which is instructed by the request receiving block 1901 to generate a control signal and generates a command generation control signal, an address generation control signal, and a data latch control signal.

The memory controller according to Embodiment 6 of the present invention changes the priority of memory access from the plurality of blocks 804, 805, and 806 so as to make access to a different bank from memory access permitted by the arbitration circuit 101 of Embodiment 1 immediately before. The memory controller according to Embodiment 6 of the present invention is different from Embodiments 1 and 4 in that the arbitration circuit 101 of Embodiment 4 changes the priority of memory access from the plurality of blocks when memory access permitted immediately before is read access, whereas the arbitration circuit 101 of Embodiment 6 comprises the arbitrating method designating unit 1902 for designating an arbitrating method for changing the priority of memory access, and Embodiment 6 has the function of designating an arbitrating method according to the setting of the arbitrating method designating unit 1902 even when memory access requests f Fmerom the plurality of blocks 804, 805, and 806 are made to the same bank as immediately preceding access and memory access permitted by the arbitration circuit 101 immediately before is read access.

When the arbitrating method designating unit 1902 is set so as to place higher priority on a bank, the request receiving block 1901 changes the priority of memory access by using the bank decision unit 1002 so as to prevent successive access to the same bank as in Embodiment 1.

Further, when the arbitrating method designating unit 1902 is set so as to place higher priority on access, the request receiving block 1901 changes the priority of memory access by using the access request unit 1502 so as to have successive read access as in Embodiment 4.

With this configuration, even when memory access requests from the plurality of blocks 804, 805, and 806 are made to the same bank as immediately preceding access and the memory controller 105 performs memory read access on the SDRAM 808, the arbitration circuit 101 lowers the priority of the block which outputs memory access to the same bank. Alternatively, the arbitration circuit 101 increases the priority of a block which outputs a memory access request to a different bank, so that access can be successively made to different banks. Alternatively, the arbitration circuit 101 increases the priority of read access and changes the priority of memory access requests so as to successively perform read access. Such operations can eliminate a wait cycle disabling access to the SDRAM 808 and improve processing time.

In Embodiment 6, the arbitrating method designating unit 1902 may be set from the outside to change the arbitrating method. Also in this case, the same effect can be obtained.

Embodiment 6 described an example where the memory is the SDRAM 808. The same effect can be obtained by other kinds of synchronous memory as well as SDRAM.

1. A memory controller for controlling a memory having a plurality of banks, comprising:
an arbitration circuit for arbitrating a memory access request for making access to the memory from a plurality of blocks,
a command generation block for generating a memory command for the memory based on a control signal from the arbitration circuit,
an address generation block which receives a memory address from the block permitted to access by the arbitration circuit and outputs the memory address to the memory, and
a data latch block which latches write data from the block permitted to access by the arbitration circuit or read data from the memory and passes data between the memory and the block permitted to access, wherein
priority of memory access from the plurality of blocks is changed so as to make access to a different bank from memory access having been permitted by the arbitration circuit immediately before.

2. The memory controller according to claim 1, wherein the arbitration circuit comprises:
a request receiving block which receives a memory request and a memory address from the plurality of blocks, includes a bank decision unit for deciding whether access is made to the same bank based on the received memory address, and provides an instruction to generate an enabling signal,
a memory access priority designating unit for designating the priority of memory access from the plurality of blocks,
an identical bank priority designating unit for selecting a block to be subsequently permitted to access when a memory access request is made from the plurality of blocks to the same bank as immediately preceding access,
an enabling signal generation block which is instructed by the request receiving block to generate the enabling signal and outputs the enabling signal to the block permitted to access the memory, and
a control signal generation block which is instructed by the request receiving block to generate the control signal and generates each control signal.

3. The memory controller according to claim 1, wherein the arbitration circuit lowers the priority of memory access made from the block to the same bank as memory access having been permitted immediately before.

4. The memory controller according to claim 1, wherein the arbitration circuit increases the priority of memory access made from the block to a bank different from memory access having been permitted immediately before.

5. The memory controller according to claim 1, wherein the arbitration circuit lowers the priority of memory access when the bank where memory access is permitted immediately before is the same as a subsequent memory access request.

6. The memory controller according to claim 2, wherein the memory access priority designating unit can be set from outside and priority of access from the plurality of blocks to the memory can be changed according to a setting of the memory access priority designating unit.

7. The memory controller according to claim 2, wherein the identical bank priority designating unit can be set from outside and a block to be subsequently permitted to access the memory can be selected according to priority set by the identical bank priority designating unit when a memory access request is made from the plurality of blocks to the same bank as immediately preceding access.

8. The memory controller according to claim 1, wherein the memory is a synchronous memory.

9. A memory controller for controlling a memory having a plurality of banks, comprising:
an arbitration circuit for arbitrating a memory access request for making access to the memory from a plurality of blocks,
a command generation block for generating a memory command for the memory based on a control signal from the arbitration circuit,
an address generation block which receives a memory address from the block permitted to access by the arbitration circuit and outputs the memory address to the memory, and
a data latch block which latches write data from the block permitted to access by the arbitration circuit or read data from the memory and passes data between the memory and the block permitted to access, wherein
bank access data is access data to the memory, the access data having a predetermined number of bytes for performing writing or reading on the same bank of the memory, block access data is a data unit constituted of two sets of the bank access data belonging to different banks, and in the case where the plurality of blocks make a memory access request for each piece of the block access data, when a second-half bank where memory access is permitted immediately before is the same as the first-half bank of a subsequent memory access request, the arbitration circuit changes an order of memory access of the bank access data in the block access data.

10. The memory controller according to claim 9, wherein the arbitration circuit comprises:
a request receiving block which receives a memory request and a memory address from the plurality of blocks, includes a bank decision unit for deciding, based on the received memory address, whether access is made to the same bank regarding a second-half bank where memory access has been permitted immediately before and a first-half bank of a subsequent memory access request, and provides an instruction to generate an enabling signal,
a memory access priority designating unit for designating priority of memory access from the plurality of blocks,
an enabling signal generation block which is instructed by the request receiving block to generate the enabling signal and outputs the enabling signal to the block permitted to access the memory, and
a control signal generation block which is instructed by the request receiving block to generate the control signal and generates each control signal.

11. The memory controller according to claim 9, wherein the data latch block comprises:
a write data latch block which receives and latches write data from the plurality of blocks,
a data change block which, based on a data latch control signal from the arbitration circuit, changes an order of bank access data outputted by the write data latch block, outputs the data as write data to the memory, changes an order of bank access data outputted by a read data latch block (described later), and outputs the data as read data to a block permitted to perform read access to the memory, and
a read data latch block which receives and latches the read data having been read from the memory.

12. The memory controller according to claim 9, wherein when the second-half bank where memory access has been permitted immediately before is the same as the first-half bank of the subsequent memory access request, the arbitration circuit changes an order of the bank access data in the block access data, reads the block access data from the memory, and stores the data in the data latch block, and the data latch block changes an order of each piece of the bank access data in the block access data and transfers the data to the block having performed memory access.

13. The memory controller according to claim 10, wherein the memory access priority designating unit can be set from outside and the priority of access from the plurality of blocks to the memory can be changed according to a setting of the memory access priority designating unit.

14. The memory controller according to claim 9, wherein the memory is a synchronous memory.

15. A memory controller for controlling a memory having a plurality of banks, comprising:
an arbitration circuit for arbitrating a memory access request for making access to the memory from a plurality of blocks,
a command generation block for generating a memory command for the memory based on a control signal from the arbitration circuit,
an address generation block which receives a memory address from the block permitted to access by the arbitration circuit and outputs the memory address to the memory, and
a data latch block which latches write data from the block permitted to access by the arbitration circuit or read data from the memory and passes data between the memory and the block permitted to access, wherein
when bank access data is access data to the memory, the access data having a predetermined number of bytes for performing writing or reading on the same bank of the memory, and block access data is a data unit constituted of two sets of the bank access data belonging to different banks, the arbitration circuit instructs the command generation block to provide a wait cycle when a memory access request is made by the bank access data alone from the block permitted to access the memory.

16. The memory controller according to claim 15, wherein the arbitration circuit comprises:
a request receiving block which receives a memory request from the plurality of blocks, includes a data unit decision unit for deciding a data unit of requested memory access based on the received memory request, and provides an instruction to generate an enabling signal,
a memory access priority designating unit for designating priority of memory access from the plurality of blocks,
a wait cycle designating unit for designating the number of wait cycles provided when memory access is requested from the plurality of blocks by the bank access data alone,
an enabling signal generation block which is instructed by the request receiving block to generate the enabling signal and outputs the enabling signal to the block permitted to access the memory, and
a control signal generation block which is instructed by the request receiving block to generate the control signal and generates each control signal.

17. The memory controller according to claim 16, wherein the memory access priority designating unit can be set from outside and the priority of access from the plurality of blocks to the memory can be changed according to a setting of the memory access priority designating unit.

18. The memory controller according to claim 16, wherein the wait cycle designating unit can be set from outside and the number of wait cycles provided by the command generation block can be changed according to a setting of the wait cycle designating unit.

19. The memory controller according to claim 15, wherein the memory is a synchronous memory.

20. A memory controller for controlling a memory having a plurality of banks, comprising:
an arbitration circuit for arbitrating a memory access request for making access to the memory from a plurality of blocks,
a command generation block for generating a memory command for the memory based on a control signal from the arbitration circuit,
an address generation block which receives a memory address from the block permitted to access by the arbitration circuit and outputs the memory address to the memory, and
a data latch block which latches write data from the block permitted to access by the arbitration circuit or read data from the memory and passes data between the memory and the block permitted to access, wherein
when memory access permitted by the arbitration circuit immediately before is read access, priority of a memory access requests from the plurality of blocks is changed so as to successively perform read access.

21. The memory controller according to claim 20, wherein the arbitration circuit comprises:
a request receiving block which receives a memory request from the plurality of blocks, includes an access request decision unit for deciding the kind of requested memory access based on the received memory request, and provides an instruction to generate an enabling signal,
a memory access priority designating unit for designating priority of memory access from the plurality of blocks,
a read access priority designating unit for selecting a block to be subsequently permitted to perform read access when memory access permitted immediately before is read access,
an enabling signal generation block which is instructed by the request receiving block to generate the enabling signal and outputs the enabling signal to the block permitted to access the memory, and
a control signal generation block which is instructed by the request receiving block to generate the control signal and generates each control signal.

22. The memory controller according to claim 20, wherein the arbitration circuit increases priority of read access when memory access permitted immediately before is read access.

23. The memory controller according to claim 20, wherein the arbitration circuit increases priority of read access when memory access permitted immediately before is read access and a subsequent memory access is made for read access.

24. The memory controller according to claim 21, wherein the memory access priority designating unit can be set from outside and the priority of access from the plurality of blocks to the memory can be changed according to a setting of the memory access priority designating unit.

25. The memory controller according to claim 20, wherein the read access priority designating unit can be set from outside and a block to be subsequently permitted to perform read access to the memory can be selected according to priority set by the read access priority designating unit when memory access permitted by the arbitration circuit immediately before is read access.

26. The memory controller according to claim 20, wherein the memory is a synchronous memory.

27. A memory controller for controlling a memory having a plurality of banks, comprising:
a refresh request block for requesting refresh at a regular interval to store the internal data of the memory,
an arbitration circuit for arbitrating a memory access request for accessing the memory from a plurality of blocks and a refresh request from the refresh request block,
a command generation block for generating a memory command for the memory based on a control signal from the arbitration circuit,
an address generation block which receives a memory address from the block permitted to access by the arbitration circuit and outputs the memory address to the memory, and
a data latch block which latches write data from the block permitted to access by the arbitration circuit or read data from the memory and passes data between the memory and the block permitted to access, wherein
when memory access permitted by the arbitration circuit immediately before is write access, priority of a refresh request from the refresh request block is changed.

28. The memory controller according to claim 27, wherein the arbitration circuit comprises:
a request receiving block which receives the refresh request from the refresh request block and the memory request from the plurality of blocks, includes an access request decision unit for deciding the kind of requested memory access based on the received refresh request and memory request, and provides an instruction to generate an enabling signal,
a memory access priority designating unit for designating priority of memory access from the plurality of blocks,
a write access priority designating unit for selecting a block to be subsequently permitted to perform read access when the refresh request is outputted from the refresh request block and memory access permitted by the arbitration circuit immediately before is write access,
an enabling signal generation block which is instructed by the request receiving block to generate the enabling signal and outputs the enabling signal to the block permitted to access the memory, and
a control signal generation block which is instructed by the request receiving block to generate the control signal and generates each control signal.

29. The memory controller according to claim 27, wherein the arbitration circuit lowers the priority of a refresh request when memory access permitted immediately before is write access.

30. The memory controller according to claim 27, wherein the arbitration circuit lowers the priority of a refresh request when memory access permitted immediately before is write access and a subsequent memory access request includes a refresh request.

31. The memory controller according to claim 28, wherein the memory access priority designating unit can be set from outside and the priority of access from the plurality of blocks to the memory can be changed according to a setting of the memory access priority designating unit.

32. The memory controller according to claim 28, wherein the write access priority order designating unit can be set from outside and a block to be subsequently permitted to access the memory can be selected according to priority set by the write access priority order designating unit when a refresh request is outputted from the refresh request block and memory access permitted by the arbitration circuit immediately before is write access.

33. The memory controller according to claim 27, wherein the memory is a synchronous memory.

34. A memory controller for controlling a memory having a plurality of banks, comprising:
an arbitration circuit for arbitrating a memory access request for making access to the memory from a plurality of blocks,
a command generation block for generating a memory command for the memory based on a control signal from the arbitration circuit,
an address generation block which receives a memory address from the block permitted to access by the arbitration circuit and outputs the memory address to the memory,
a data latch block which latches write data from the block permitted to access by the arbitration circuit or read data from the memory and passes data between the memory and the block permitted to access,
wherein the arbitration circuit designates an arbitrating method for changing priority of memory access from the plurality of blocks when the memory access request from the plurality of blocks is made to the same bank as immediately preceding access and memory access permitted by the arbitration circuit immediately before is read access.

35. The memory controller according to claim 34, wherein the arbitration circuit comprises:
a bank decision unit which receives a memory address from the plurality of blocks and decides whether access is made to the same bank or not based on the received memory address,
an access request decision unit which receives a memory request from the plurality of blocks and decides the kind of requested memory access based on the received memory request,
a request receiving block which includes the bank decision unit and the access request decision unit and provides an instruction to generate an enabling signal,
a memory access priority designating unit for designating the priority of memory access from the plurality of blocks,
an arbitrating method designating unit for designating an arbitrating method for changing the priority of memory access when the memory access request from the plurality of blocks is made to the same bank as immediately preceding access and memory access permitted by the arbitration circuit immediately before is read access,
an identical bank priority designating unit for selecting a block to be subsequently permitted to access when the arbitrating method designating unit is set so as to place higher priority on a bank,
a read access priority designating unit for selecting a block to be subsequently permitted to perform read access when the arbitrating method designating unit is set so as to place higher priority on access,
an enabling signal generation block which is instructed by the request receiving block to generate the enabling signal and outputs the enabling signal to the block permitted to access the memory, and
a control signal generation block which is instructed by the request receiving block to generate the control signal and generates each control signal.

36. The memory controller according to claim 35, wherein the memory access priority designating unit can be set from outside and the priority of access from the plurality of blocks to the memory can be changed according to a setting of the memory access priority designating unit.

37. The memory controller according to claim 35, wherein the arbitrating method designating unit can be set from outside and the arbitrating method of memory access from the plurality of blocks can be changed according to a setting of the arbitrating method designating unit.

38. The memory controller according to claim 35, wherein the identical bank priority designating unit can be set from outside and a block to be subsequently permitted to access to the memory can be selected according to priority set by the identical bank priority designating unit when the arbitrating method designating unit is set so as to place higher priority on a bank and a memory access request is made from the plurality of blocks to the same bank as immediately preceding access.

39. The memory controller according to claim 35, wherein the read access priority designating unit can be set from outside and a block to be subsequently permitted to perform read access to the memory can be selected according to priority set by the read access priority designating unit when the arbitrating method designating unit is set so as to place higher priority on access and memory access permitted by the arbitration circuit immediately before is read access.

40. The memory controller according to claim 34, the memory is a synchronous memory.
